(19) United States
(12) Patent Application Publication
(10) Pub. No.: US 2018/0086234 A1
(43) Pub. Date: Mar. 29, 2018

(54) VEHICLE SEAT DEVICE

(71) Applicant: AISIN SEIKI KABUSHIKI KAISHA, Kariya-shi (JP)

(72) Inventors: Yasuhiro KOJIMA, Kariya-shi (JP); Hideo NIHONMATSU, Anjo-shi (JP); Koichi MORITA, Kariya-shi (JP)

(73) Assignee: AISIN SEIKI KABUSHIKI KAISHA, Kariya-shi (JP)

(21) Appl. No.: 15/564,570

(22) PCT Filed: Mar. 30, 2016
(86) PCT No.: PCT/JP2016/060414

§ 371 Date: Oct. 5, 2017

(30) Foreign Application Priority Data
Apr. 10, 2015 (JP) 2015-080971

(51) Int. Cl. B60N 2/08; B60N 2/22

(52) U.S. Cl. CPC B60N 2/0881; B60N 2/224; B60N 2/2227

(57) ABSTRACT

A vehicle seat device includes a first movable member, which moves forward and rearward integrally with a seat, a first engagement member, which is engaged with or disengaged from the first movable member based on a forward or rearward movement of the seat, a second engagement member, which operates integrally with a seatback of the seat, a second movable member, which is capable of approaching and moving away from a movement path of the second engagement member, and an interlocking mechanism, which interlocks the first movable member and the second movable member with each other. The first movable member is configured to be in a first engagement/disengagement state when the seat is in a rear movement region and to be in a second engagement/disengagement state when the seat is in a front movement region. The second movable member is configured to enter the movement path of the second engagement member to restrict a rearward tilting action range of the seatback. The interlocking mechanism is configured to cause the second movable member to enter the movement path of the second engagement member when the seat is in the rear movement region.

### TECHNICAL FIELD

The present invention relates to a vehicle seat device.

### BACKGROUND ART

A typical vehicle seat is supported to be movable in the front-rear direction on slide rails provided on the vehicle floor. The seatback is tiltable by being supported at the rear end of the seat cushion via the recliner. An occupant of the vehicle can arbitrarily adjust the seat position and the sitting posture by using the functions of the seat slide device including slide rails and the seat reclining device including a recliner.

In addition, when these sliding and reclining functions are used at the same time, the seatback tilted rearward may project out of the passenger compartment, for example, into the cargo space or the exterior of the vehicle, depending on the movement position of the seat. In view of this, for example, the vehicle seat device described in Patent Document 1 includes a locking member. When the seatback is in the rearward tilting action region beyond a predetermined tilt angle, the locking member engages with the operation lever of the seat slide device, thereby preventing the rearward sliding operation performed by the seat slide device. The vehicle seat device described in Patent Document 2 includes a locking member. In the rear movement region of the seat, the locking member engages with the operation lever of the seat reclining device to prevent the rearward tilting action of the seatback performed by the seat reclining device.

### PRIOR ART DOCUMENTS

### Patent Documents

Patent Document 1: Japanese Laid-Open Patent Publication No. 64-1341

Patent Document 2: Japanese Laid-Open Patent Publication No. 64-1342

### SUMMARY OF THE INVENTION

### Problems that the Invention is to Solve

However, in the conventional technique described in the above-mentioned Patent Document 1, when there is a possibility that the rearward tilted seatback will be caused to project out of the passenger compartment by the rearward movement of the seat, the rearward moving operation of the seat is prevented even if the operation is within a range in which the seatback does not project out of the passenger compartment. Also, in the conventional technique described in the above-mentioned Patent Document 2, when the seat is in the rear movement region, in which rearward tilting will possibly cause the seatback to project out of the passenger compartment, the rearward tilting action of the seatback is prevented even if the operation is within a range in which the seatback does not project out of the passenger compartment. Since these configurations hamper convenience, there is still room for improvement.

An objective of the present invention is to provide a vehicle seat device capable of preventing a rearward tilted seatback from projecting out of the passenger compartment, while ensuring the convenience.

### Means for Solving the Problems

To achieve the foregoing objective and in accordance with one aspect of the present invention, a vehicle seat device is provided that includes a first movable member, which moves forward and rearward integrally with a seat supported on a slide rail, a first engagement member, which is engaged with or disengaged from the first movable member based on forward or rearward movement of the seat, a second engagement member, which operates integrally with a seatback of the seat, a second movable member, which is capable of approaching and moving away from a movement path that is taken by the second engagement member when the seatback is tilted, and an interlocking mechanism, which interlocks the first movable member and the second movable member with each other. The first movable member is configured to be in a first engagement/disengagement state when the seat is in a rear movement region. The first movable member is configured to be in a second engagement/disengagement state when the seat is in a front movement region. One of the first engagement/disengagement state and the second engagement/disengagement state is a state in which the first movable member is engaged with the first engagement member. The other one of the first engagement/disengagement state and the second engagement/disengagement state is a state in which the first movable member is disengaged from the first engagement member. The second movable member is configured to enter the movement path of the second engagement member to restrict a rearward tilting action range of the seatback. The interlocking mechanism is configured to cause the second movable member to enter the movement path of the second engagement member when the seat is in the rear movement region. The interlocking mechanism is configured to cause the second movable member to exit the movement path of the second engagement member when the seat is in the front movement region.

### BRIEF DESCRIPTION OF THE DRAWINGS

FIG. 1 is a schematic diagram of a vehicle seat according to a first embodiment.

FIG. 2 is a partial side view of a vehicle seat device according to the first embodiment.

FIG. 3 is a partial front view of the vehicle seat device according to the first embodiment.

FIG. 4 is a partial perspective view of the vehicle seat device according to the first embodiment.

FIG. 5 is an exploded perspective view of the vehicle seat device according to the first embodiment.

FIG. 6 is a partial side view of the vehicle seat device according to the first embodiment, illustrating a pivot link supported by a lower bracket.

FIG. 7 is a partial side view illustrating a state in which the pivot link of FIG. 6 engages with a first engagement member.

FIG. 8 is a partial side view illustrating a state in which the pivot link has been moved further forward from the state of FIG. 7.

FIG. 9 is a partial side view of the vehicle seat device according to the first embodiment, illustrating an upper portion of the lower bracket.

FIG. 10 is a perspective view of a slider, a base bracket, and a torsion coil spring.

FIG. 11 is a cross-sectional view taken along line XI-XI of FIG. 9.

FIG. 12 is a cross-sectional view taken along line XII-XII of FIG. 9.

FIG. 13 is a partial side view of a part of the vehicle seat device where a second engagement member is attached to the upper bracket, illustrating an entered state of the slider.

FIG. 14 is a partial side view of a part of the vehicle seat device where a second engagement member is attached to the upper bracket, illustrating an exited state of the slider.

FIG. 15 is a partial side view of a part of the vehicle seat device where a second engagement member is attached to the upper bracket, illustrating an entry prevented state of the slider.

FIG. 16 is a partial side view of the pivot link when retained in the pivoted attitude at which the pivot link engages with the first engagement member.

FIG. 17 is an explanatory diagram of operation of the vehicle seat device, illustrating a state in which the seat is in the rear movement region.

FIG. 18 is an explanatory diagram of operation of the vehicle seat device, illustrating a state in which the seat is in the front movement region and the seatback is in a restriction range of the rearward tilting action.

FIG. 19 is an explanatory diagram of operation of the vehicle seat device, illustrating a state in which the seat is in the front movement region and the seatback is maximally tilted rearward.

FIG. 20 is a partial side view of a vehicle seat device according to a second embodiment, illustrating a state in which the seat is in the rear movement region and the pivot link and a third engagement member are in a disengaged state.

FIG. 21 is a partial side view of the third engagement member of the vehicle seat device, illustrating a disengaged state of the pivot link and the third engagement member.

FIG. 22 is a partial side view of the third engagement member of the vehicle seat device, illustrating an engaged state of the pivot link and a third engagement step portion.

FIG. 23 is a partial side view of the third engagement member of the vehicle seat device, illustrating an engaged state of the pivot link and a second engagement step portion.

FIG. 24 is a partial side view of the third engagement member of the vehicle seat device, illustrating an engaged state of the pivot link and a first engagement step portion.

FIG. 25 is a partial side view of the third engagement member of the vehicle seat device, illustrating an engaged state of the pivot link and the first engagement member.

FIG. 26 is a partial side view showing the locking portion of the slider according to the second embodiment, illustrating an entered state of a fourth insertion portion.

FIG. 27 is a partial side view showing the locking portion of the slider according to the second embodiment, illustrating an entered state of a third insertion portion.

FIG. 28 is a partial side view showing the locking portion of the slider according to the second embodiment, illustrating an entered state of a second insertion portion.

FIG. 29 is a partial side view showing the locking portion of the slider according to the second embodiment, illustrating an entered state of a first insertion portion.

FIG. 30 is a partial side view showing the locking portion of the slider according to the second embodiment, illustrating an exited state.

FIG. 31 is a partial side view of the vehicle seat device of the second embodiment, illustrating a state in which the seat is in the front movement region.

FIG. 32 is a partial side view of the vehicle seat device according to the second embodiment, illustrating a state in which the seat is in the rear movement region and the pivot link and the third engagement member are in a disengaged state.

FIG. 33 is a partial side view of the upper end of a lower bracket in a vehicle seat device according to a modification.

### MODES FOR CARRYING OUT THE INVENTION

### First Embodiment

A vehicle seat device 30 according to a first embodiment will now be described with reference to the drawings.

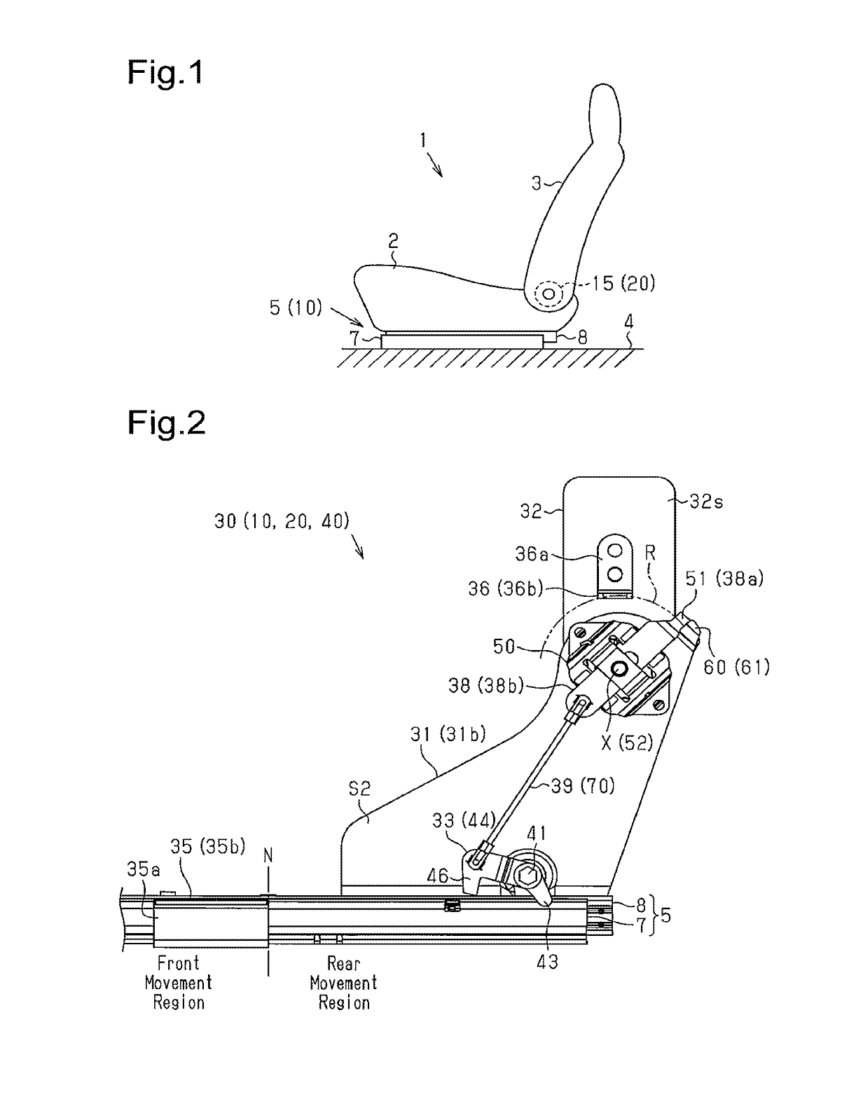

As shown in FIG. 1, a vehicle seat 1 includes a seat cushion 2 and a seatback 3 tiltably provided at the rear end of the seat cushion 2. The seat 1 is supported on a pair of right and left slide rails 5 provided on a vehicle floor 4.

Specifically, each of the slide rails 5 includes a lower rail 7 and an upper rail 8. The lower rail 7 is fixed to the vehicle floor 4 and extends in the front-rear direction of the vehicle. The upper rail 8 is movable relative to the lower rail 7 in the extending direction of the lower rail 7. That is, the seat 1 of the present embodiment is configured such that (the side frames of) the seat cushion 2 is fixed to the upper rails 8, which are components of the slide rails 5. A lock mechanism (not shown) is provided between the lower rails 7 and the upper rails 8. The lock mechanism switches between a state in which the relative movement of the upper rails 8 with respect to the lower rails 7 is restricted and a state in which such relative movement is allowed. In the present embodiment, the slide rails 5 constitute a seat slide device 10, which is capable of adjusting the position of the seat 1 in the front-rear direction.

The seat 1 of the present embodiment includes a recliner 15 between the seat cushion 2 and the seatback 3. The recliner 15 is capable of restricting and allowing for relative rotation of the seatback 3 with respect to the seat cushion 2. In the present embodiment, the recliner 15 constitutes a seat reclining device 20, which is capable of adjusting the tilt angle of the seatback 3.

In the present embodiment, the seat slide device 10 and the seat reclining device 20 are integrally configured as the vehicle seat device 30 as shown in FIGS. 2 to 5.

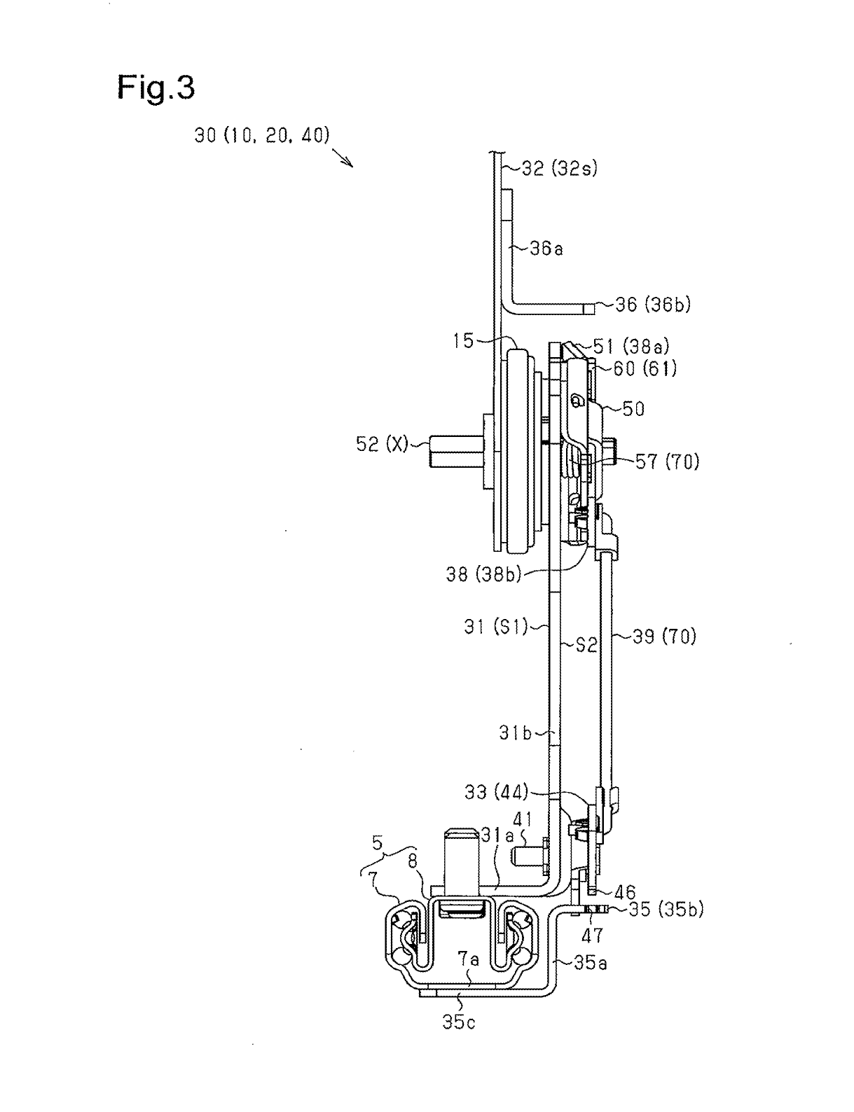

Specifically, the vehicle seat device 30 of the present embodiment includes a lower bracket 31 and an upper bracket 32. The lower bracket 31 is supported on the slide rail 5 to be moved forward or rearward integrally with the seat 1. The upper bracket 32 is coupled to the lower bracket 31 via the recliner 15. The lower bracket 31 of the present embodiment has a fixed portion 31a fixed to the upper rail 8 and a vertical wall portion 31b extending in the vertical direction. The lower bracket 31 is arranged to be upright on the slide rail 5. Further, the recliner 15 of the present embodiment has an outer shape of a substantially flattened cylinder (disk shape). One side in the thickness direction of the recliner 15 (the right side as viewed in FIG. 3) is fixed to the vertical wall portion 31b of the lower bracket 31. Specifically, the right side is fixed to part that is close to the upper end of the vertical wall portion 31b (the upper end as viewed in FIG. 3). Furthermore, the upper bracket 32 of the present embodiment has an outer shape of an elongated rectangular plate and is fixed to the other side of the recliner 15 (the left side as viewed in FIG. 3) to be arranged parallel to the vertical wall portion 31b of the lower bracket 31. In the vehicle seat device 30 of the present embodiment, the side frame (not shown) of the seatback 3 is fixed to the upper bracket 32, so that the seatback 3 is tiltably supported at the rear end of the seat cushion 2, which is supported on the slide rails 5.

Seatback Projection Preventing Device

Next, a projection preventing device of the seatback 3 of the present embodiment will be described. The projection preventing device is configured by the vehicle seat device 30.

As shown in FIGS. 2 to 5, the vehicle seat device 30 of the present embodiment includes a pivot link 33, which is supported by the lower bracket 31 to move forward and rearward integrally with the seat 1, and a first engagement member 35. The pivot link 33 engages with and disengages from the first engagement member 35 based on the forward and rearward movement of the seat 1. Further, the vehicle seat device 30 of the present embodiment includes a second engagement member 36, which is fixed to the upper bracket 32 to operate integrally with the seatback 3, and a slider 38, which functions as a second movable member. The slider 38 is supported by the lower bracket 31 to approach and move away from a movement path R that is taken by the second engagement member 36 when the seatback 3 is tilted. Furthermore, the vehicle seat device 30 of the present embodiment is provided with a coupling rod 39 arranged between the slider 38 and the pivot link 33. Specifically, the coupling rod 39 of the present embodiment is a rigid body capable of transmitting a pushing force. Accordingly, the seat device 30, according to the present embodiment, configures a projection preventing device 40 that interlocks the pivot link 33 and the slider 38 with each other to prevent the rearward tilted seatback 3 from projecting out of the passenger compartment.

Specifically, in the vehicle seat device 30 of the present embodiment, the pivot link 33, which constitutes a first movable member, is pivotally supported by a support shaft 41 provided on the lower bracket 31. In the present embodiment, the support shaft 41 is provided in the vicinity of the lower end of the vertical wall portion 31b of the lower bracket 31 to extend through the vertical wall portion 31b in the thickness direction (the left-right direction as viewed in FIG. 3). The vertical wall portion 31b has a first surface S1, to which the recliner 15 is fixed, and a second surface S2 (the right side as viewed in FIG. 3), which is the back side with respect to the first side S1. The pivot link 33 of the present embodiment is pivotally supported by the support shaft 41 to be arranged on the second surface S2 of the vertical wall portion 31b.

The pivot link 33 of the present embodiment has a first engagement protrusion 43 extending radially outward of the support shaft 41, which is the rotation center. The pivot link 33 of the present embodiment is structured such that the first engagement protrusion 43 engages with and disengages from the first engagement member 35 to pivot about the support shaft 41.

The first engagement member 35 of the present embodiment has a vertical plate portion 35a extending upright on the side of the slide rail 5, and a flange-shaped lateral plate portion 35b, which extends from the upper end of the vertical plate portion 35a toward the outer side in the width direction (the right side as viewed in FIG. 3) of the slide rail 5. Further, the first engagement member 35 has a flat plate-shaped fixed portion 35c extending from the lower end of the vertical plate portion 35a on the opposite side (the left side as viewed in FIG. 3) to the extending direction of the lateral plate portion 35b. In addition, the first engagement member 35 of the present embodiment is formed by plastic working (bending process) of a metal plate material. That is, the first engagement member 35 of the present embodiment is configured such that the fixed portion 35c is fixed to the lower surface of the slide rail 5 (the bottom 7a of the lower rail 7) so that the vertical plate portion 35a and the lateral plate portion 35b, which have a substantially L-shaped end face shape (cross-sectional shape), are arranged on the side of the slide rail 5. Then, the first engagement member 35 of the present embodiment is configured such that, based on the forward and rearward movement of the seat 1, the first engagement protrusion 43 of the pivot link 33 engages with and disengages from the lateral plate portion 35b on the side of the slide rail 5.

More specifically, as shown in FIG. 2, in the vehicle seat device 30 of the present embodiment, the first engagement member 35 is arranged in a front movement region of the seat 1. Further, the first engagement member 35 of the present embodiment extends along the extending direction of the slide rail 5. The rear end of the first engagement member 35 is arranged at an engagement/disengagement position N, at which the pivot link 33 of the present embodiment contacts the first engagement member 35 as the seat 1 moves forward and is disengaged from the first engagement member 35 as the seat 1 moves rearward.

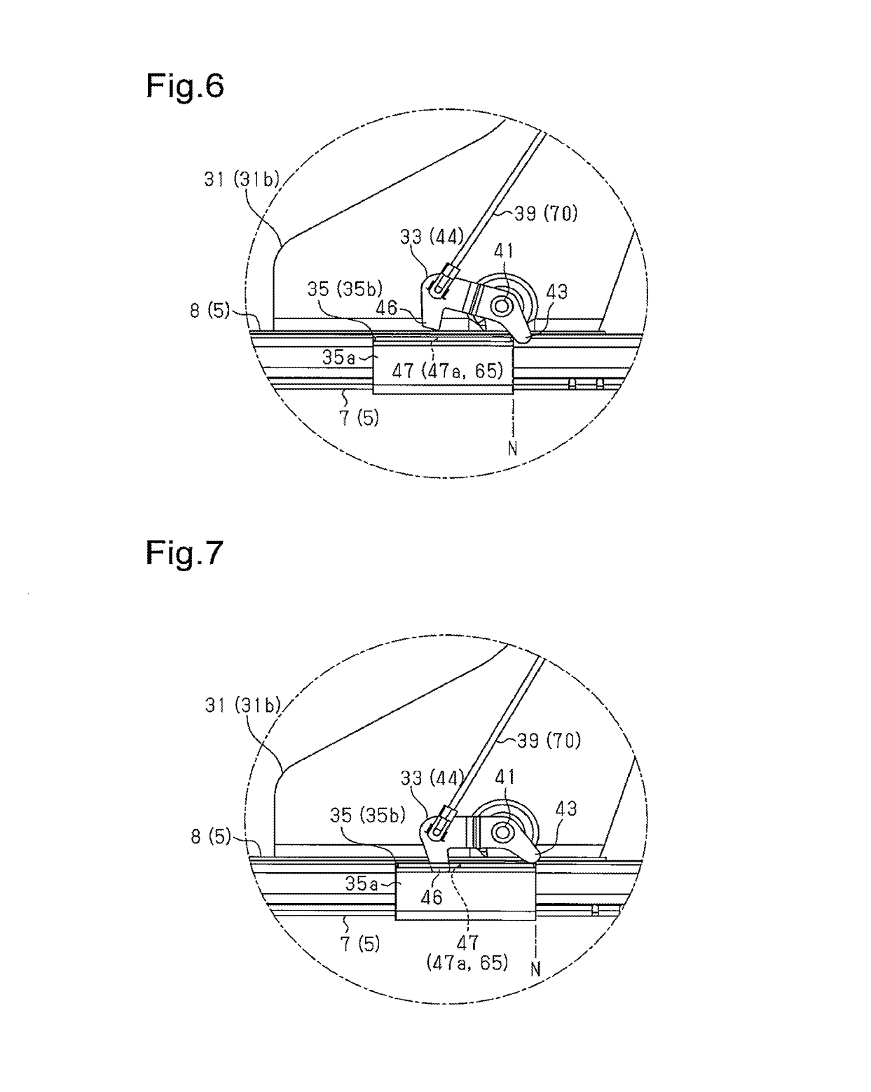

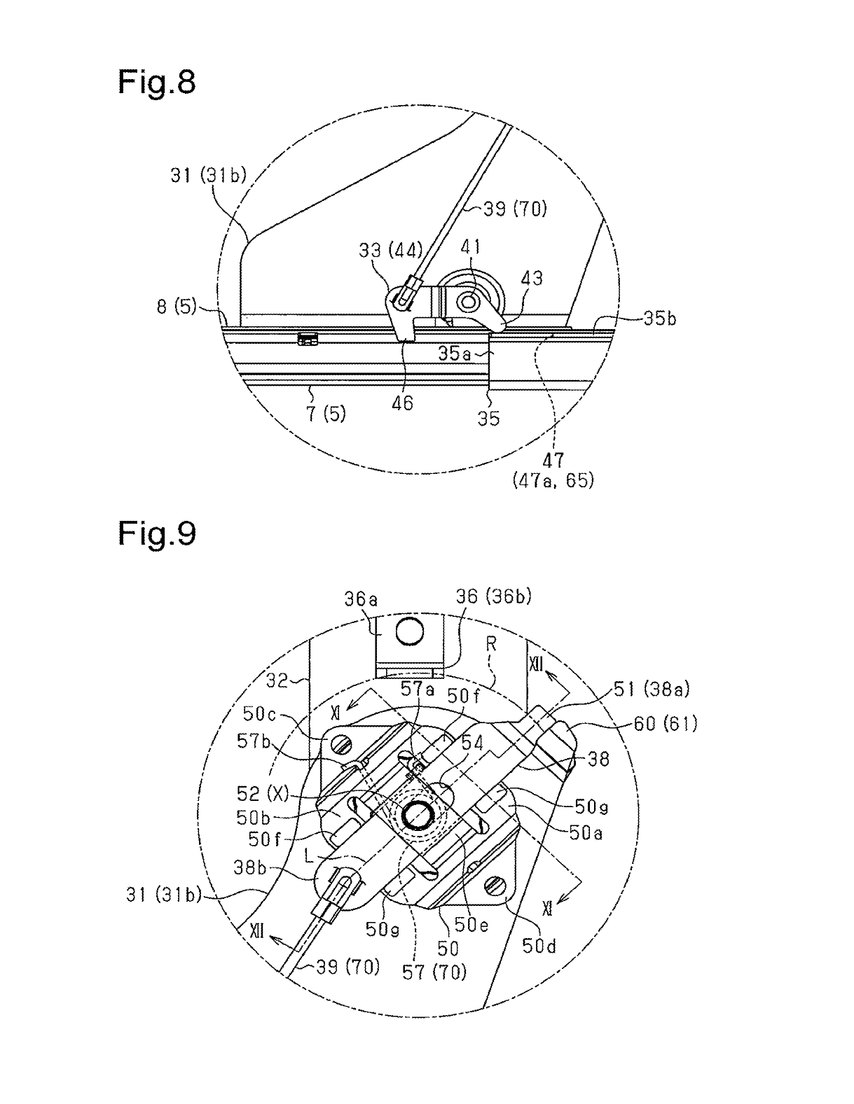

Specifically, as shown in FIG. 6, the pivot link 33 of the present embodiment moves forward together with the seat 1 so that the first engagement protrusion 43 contacts the lateral plate portion 35b of the first engagement member 35. Further, the seat 1 moves forward from this state, the pivot link 33 pivots counterclockwise as viewed in FIG. 7, and the first engagement protrusion 43 gets onto the lateral plate portion 35b, which constitutes the engagement portion of the first engagement member 35, as shown in FIG. 7. The first engagement member 35 of the present embodiment is configured such that the first engagement protrusion 43 on the lateral plate portion 35b is slidable along the extending direction of the slide rail 5. As shown in FIGS. 7 and 8, the vehicle seat device 30 of the present embodiment is configured to allow the seat 1 to move forward and rearward while maintaining engagement of the pivot link 33 with the first engagement member 35.

As shown in FIGS. 6 to 8, the pivot link 33 of the present embodiment has a coupling portion 44, which extends from the opposite side of the support shaft 41 from the first engagement protrusion 43. In the present embodiment, the coupling rod 39 is pivotally connected to the distal end of the coupling portion 44.

That is, when the first engagement protrusion 43 engages with the lateral plate portion 35b of the first engagement member 35, the pivotal link 33 of the present embodiment pivots counterclockwise as viewed in FIGS. 6 to 8, thereby pulling down the coupling rod 39, which is connected to the coupling portion 44. When the first engagement protrusion 43 is disengaged from the lateral plate portion 35b of the first engagement member 35, the pivot link 33 pivots clockwise as viewed in the drawings, thereby pushing up the coupling rod 39, which is connected to the coupling portion 44.

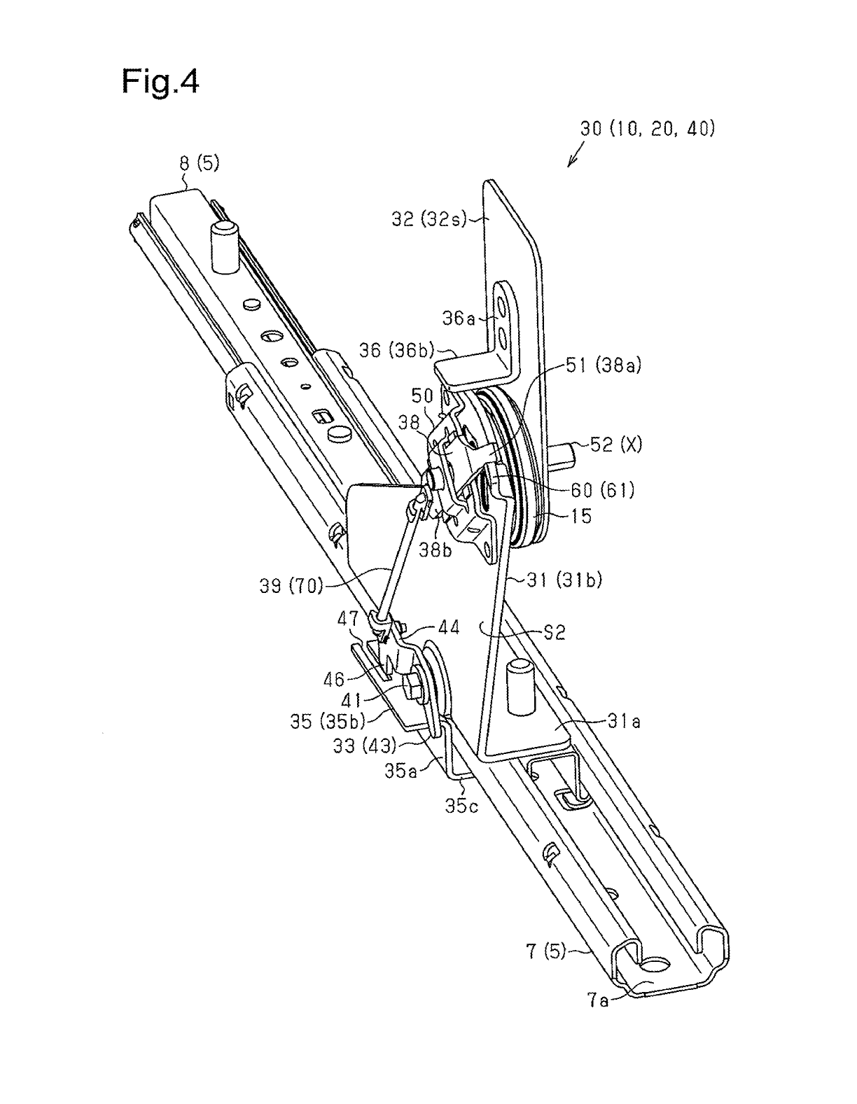

Furthermore, the pivot link 33 of the present embodiment is provided with a second engagement protrusion 46, which projects downward from the distal end of the coupling portion 44. As shown in FIGS. 4 and 7, the lateral plate portion 35b of the first engagement member 35 has an elongated hole 47 extending in the extending direction of the slide rail 5. In the first engagement member 35 of the present embodiment, the elongated hole 47 has a slit shape opening at the front end portion (the left end portion in FIG. 7) of the lateral plate portion 35b. In the vehicle seat device 30 of the present embodiment, when the first engagement protrusion 43 of the pivot link 33 contacts the lateral plate portion 35b of the first engagement member 35, so that the pivot link 33 pivots, the second engagement protrusion 46 is inserted into the elongated hole 47 in the lateral plate portion 35b of the first engagement member 35.

That is, the first engagement member 35 of the present embodiment allows for relative movement of the pivot link 33 in the range in which the second engagement protrusion 46 of the pivot link 33 in the elongated hole 47 can move along the extending direction of the elongated hole 47. Accordingly, the vehicle seat device 30 allows the seat 1 to be moved forward and rearward within the range in which relative movement of the pivot link 33 is permitted in state in which the pivot link 33 is engaged with the first engagement member 35.

As shown in FIGS. 3 to 5, the second engagement member 36 of the present embodiment includes a fixed portion 36a, which is fixed to the upper bracket 32, and a substantially plate-shaped engagement portion 36b, which projects toward the side corresponding to the lower bracket 31 (the rightward as viewed in FIG. 3) in such a manner as to intersect with the longitudinal direction (the vertical direction as viewed in FIG. 3) of the upper bracket 32, which extends in the vertical direction of the seatback 3. Specifically, the second engagement member 36 of the present embodiment is formed by bending a plate material into a substantially L-shape. One side of the two plate-shaped portions that intersect to form a substantially L-shape is the fixed portion 36a, which is fixed to a side surface 32s of the upper bracket 32.

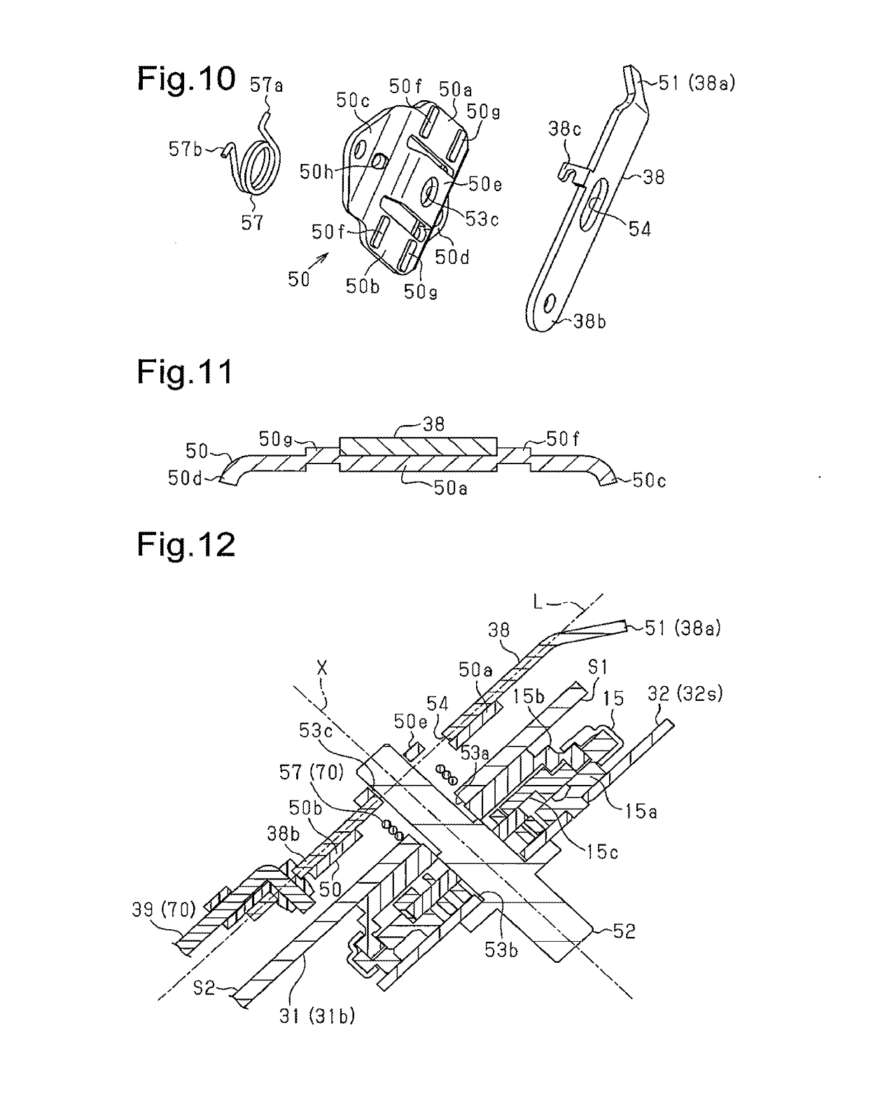

As shown in FIGS. 9 and 10, in the vehicle seat device 30 of the present embodiment, the slider 38, which constitutes the second movable member, has a shape of a substantially elongated flat plate. The lower bracket 31 is provided with a base bracket 50, which supports the slider 38 in the vicinity of the upper end of the vertical wall portion 31b. The slider 38 of the present embodiment slides along the longitudinal direction while being supported by the base bracket 50, so that a locking portion 51 provided at a first longitudinal end 38a enters or exits the movement path R, which is taken by (the engagement portion 36b of) the second engagement member 36 when the seatback 3 is tilted.

Specifically, as described above, the base bracket 50 of the present embodiment supports the slider 38 on the second surface S2 (right side as viewed in FIG. 3) of the vertical wall portion 31b at the position on the back of the recliner 15, which is fixed to the first surface S1 of the vertical wall portion 31b of the lower bracket 31.

As shown in FIGS. 9 and 10, the base bracket 50 of the present embodiment includes a pair of base portions 50a, 50b each having a shape of a substantially flat plate. Also, the base bracket 50 includes a pair of support portions 50c, 50d. The support portions 50c and 50d are fixed to the vertical wall portion 31b of the lower bracket 31 so as to support the respective base portions 50a and 50b on the same plane at a position disengaged from the second surface S2 of the vertical wall portion 31b. Furthermore, the base bracket 50 has a holding plate 50e, which has an outer shape like a substantially flat plate and is arranged on a plane parallel to the base portions 50a and 50b. The base bracket 50 of the present embodiment is configured to slidably support the slider 38 by sandwiching the slider 38 between the holding plate 50e and the respective base portions 50a, 50b.

Specifically, in the base bracket 50 of the present embodiment, the base portions 50a, 50b are arranged at two positions separated from each other in the longitudinal direction of the slider 38, which is supported by the base portions 50a, 50b, in such a manner that the opposite ends of the base portions 50a, 50b are supported by the support portions 50c, 50d. The holding plate 50e is arranged between the base portions 50a and 50b, which are spaced apart in the longitudinal direction of the slider 38.

In the base bracket 50 of the present embodiment, the base portions 50a, 50b, the support portions 50c, 50d, and the holding plate 50e are integrally formed by plastic working (pressing) a metal plate material. Further, as shown in FIGS. 9 to 11, the base portions 50a, 50b have guide portions 50f, 50g, respectively. The guide portions 50f, 50g are brought into sliding contact with the opposite ends in the width direction (the opposite ends in the left-right direction in FIG. 11) of the slider 38, which is sandwiched between the holding plate 50e and the base portions 50a, 50b. With this structure, the base bracket 50 of the present embodiment can stably allow the slider 38, which is supported by the base bracket 50, to slide in the longitudinal direction.

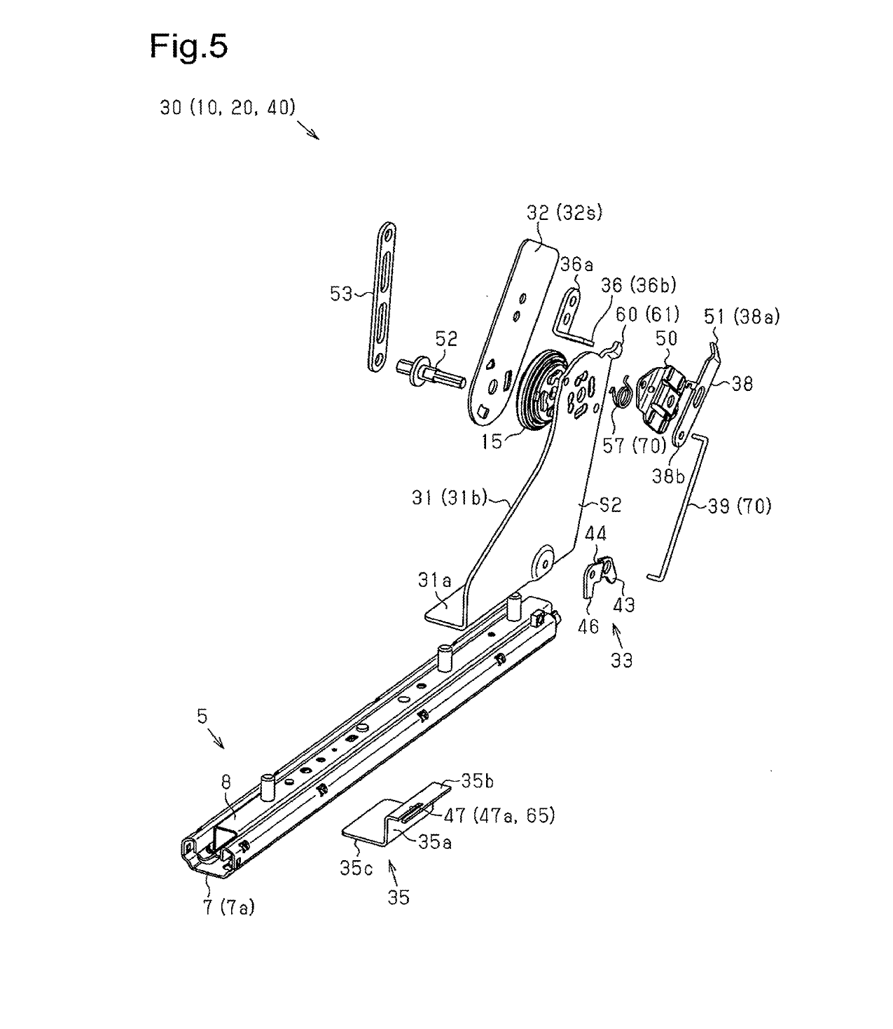

As shown in FIG. 12, the recliner 15 of the vehicle seat device 30 of the present embodiment includes a pair of rotational members 15a, 15b and a locking mechanism 15c. The rotational members 15a, 15b are coaxial and rotational relative to each other. The locking mechanism 15c engages with the rotational members 15a, 15b to restrict relative rotation of the rotational members 15a, 15b. That is, the recliner 15 has a known configuration capable of locking and unlocking the locking mechanism 15c by rotating an operation shaft 52, which passes through the rotational center of the rotational members 15a, 15b. Further, in the present embodiment, the operation shaft 52 of the recliner 15 is supported in a manner of extending through through-holes 53a to 53c provided in the lower bracket 31, the upper bracket 32, and the holding plate 50e of the base bracket 50. One end of the operation shaft 52 is fixed to a pivot lever 53 for rotating the operation shaft 52 (see FIG. 5).

Also, as shown in FIGS. 9, 10, and 12, the slider 38 of the present embodiment has an elongated hole 54 extending in the longitudinal direction thereof. Furthermore, the base bracket 50 of the present embodiment is configured such that the operation shaft 52 of the recliner 15 is inserted into the elongated hole 54 of the slider 38. The vehicle seat device 30 of the present embodiment is configured such that the slider 38, which is supported by the base bracket 50, reciprocates on a straight line L, which passes through the rotation center of the rotational members 15a, 15b, which are components of the recliner 15. That is, the straight line L passes through the tilt axis X of the seatback 3, which is formed by the recliner 15.

As shown in FIGS. 2 to 5 and 10, the slider 38 of the present embodiment is supported by the base bracket 50 in a state in which the first longitudinal end 38a is arranged on the upper side and a second longitudinal end 38b is arranged on the lower side. Further, as shown in FIGS. 9, 10, and 12, the vehicle seat device 30 of the present embodiment includes a torsion coil spring 57 as an urging member, which is arranged between the slider 38 and the base bracket 50. In the present embodiment, while being inserted into the operation shaft 52 of the recliner 15, the torsion coil spring 57 is arranged between the vertical wall portion 31b of the lower bracket 31 and the base bracket 50, which is fixed to the vertical wall portion 31b. Further, the slider 38 and (the support portion 50c of) the base bracket 50 respectively have engagement portions 38c, 50h, which are engaged with ends 57a, 57b of the torsion coil spring 57. The slider 38 of the present embodiment is urged upward by the elastic force (elastic restoring force) of the torsion coil spring 57, such that the first longitudinal end 38a of the slider 38 of the present embodiment projects upward from the upper end of (the vertical wall portion 31b of) the lower bracket 31.

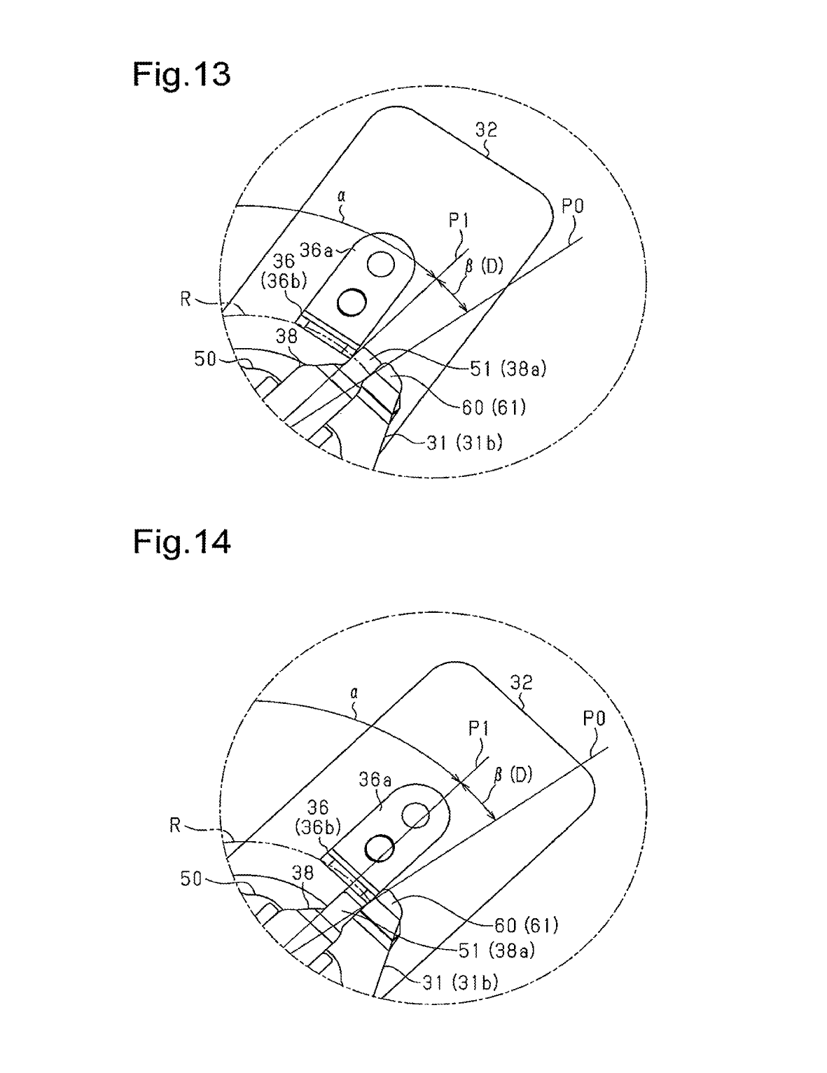

That is, as shown in FIGS. 9 and 13, the slider 38 of the present embodiment slides in the longitudinal direction based on the urging force of the torsion coil spring 57, so that the locking portion 51, which is provided at the first longitudinal end 38a, enters the movement path R, which is taken by the second engagement member 36 when the seatback 3 is tilted. In the vehicle seat device 30 of the present embodiment, the locking portion 51 of the slider 38 prevents the rearward movement of the second engagement member 36, thereby restricting the rearward tilting action range of the seatback 3.

More specifically, in the vehicle seat device 30 of the present embodiment, the vertical wall portion 31b of the lower bracket 31 includes a stopper portion 60 projecting upward from the upper end portion. The second engagement member 36 of the present embodiment is structured to engage with the stopper portion 60 when the seatback 3 tilts rearward.

That is, as shown in FIG. 14, the vehicle seat device 30 of the present embodiment is configured such that, when the locking portion 51 of the slider 38 is retracted from the movement path R of the second engagement member 36, relative rotation of the upper bracket 32 with respect to the lower bracket 31 is restricted at a position at which the second engagement member 36 engages with the stopper portion 60. This defines the maximum rearward tilt position P0 of the seatback 3 of the present embodiment.

In the present embodiment, the first longitudinal end 38a of the slider 38 projects upward relative to the lower bracket 31 except for the stopper portion 60 in a state in which the side the locking portion 51 is in sliding contact with the stopper 60 as shown in FIG. 13. The position at which the second engagement member 36 engages with the locking portion 51, which has entered the movement path R, is defined as a rearward tilt limit position P1. It is possible to limit the rearward tilting action range of the seatback 3 within the tilt region α on the front side of the rearward tilt limit position P1.

That is, the slider 38 of the present embodiment locks the second engagement member 36, which operates integrally with the seatback 3, in a state in which the locking portion 51 is sandwiched between the stopper portion 60 and the second engagement member 36. The vehicle seat device 30 of the present embodiment is thus configured such that the adjustable tilt angle of the seatback 3 decreases by a predetermined angle that is defined by an insertion width D of the locking portion 51 sandwiched between the stopper portion 60 and the second engagement member 36.

Further, since the side of the locking portion 51 provided at the first longitudinal end 38a of the slider 38 is brought into sliding contact with the stopper portion 60 provided on the lower bracket 31, the stopper portion 60 functions as a support portion 61, which supports the slider 38, which has entered the movement path R of the second engagement member 36, from behind. As a result, the vehicle seat device 30 can stably maintain the attitude of entry of the slider 38 against the pushing force of the second engagement member 36, which engages with the locking portion 51 of the slider 38.

As shown in FIGS. 2 to 5 and 9, the slider 38 of the present embodiment is configured such that the coupling rod 39 is pivotally connected to the second longitudinal end portion 38b, which is arranged below the base bracket 50.

That is, the slider 38 of the present embodiment slides in the upward and rightward direction as viewed in FIG. 9 based on the urging force of the torsion coil spring 57, thereby pulling up the coupling rod 39, which is connected to the second longitudinal end portion 38b, and the locking portion 51 provided at the first longitudinal end 38a enters the movement path R of the second engagement member 36. Further, when the part corresponding to the second longitudinal end portion 38b is pulled down to the coupling rod 39, the slider 38 slides in the leftward and downward direction as viewed in FIG. 9 against the urging force of the torsion coil spring 57. As a result, the locking portion 51 provided at the first longitudinal end 38a retracts from the movement path R of the second engagement member 36.

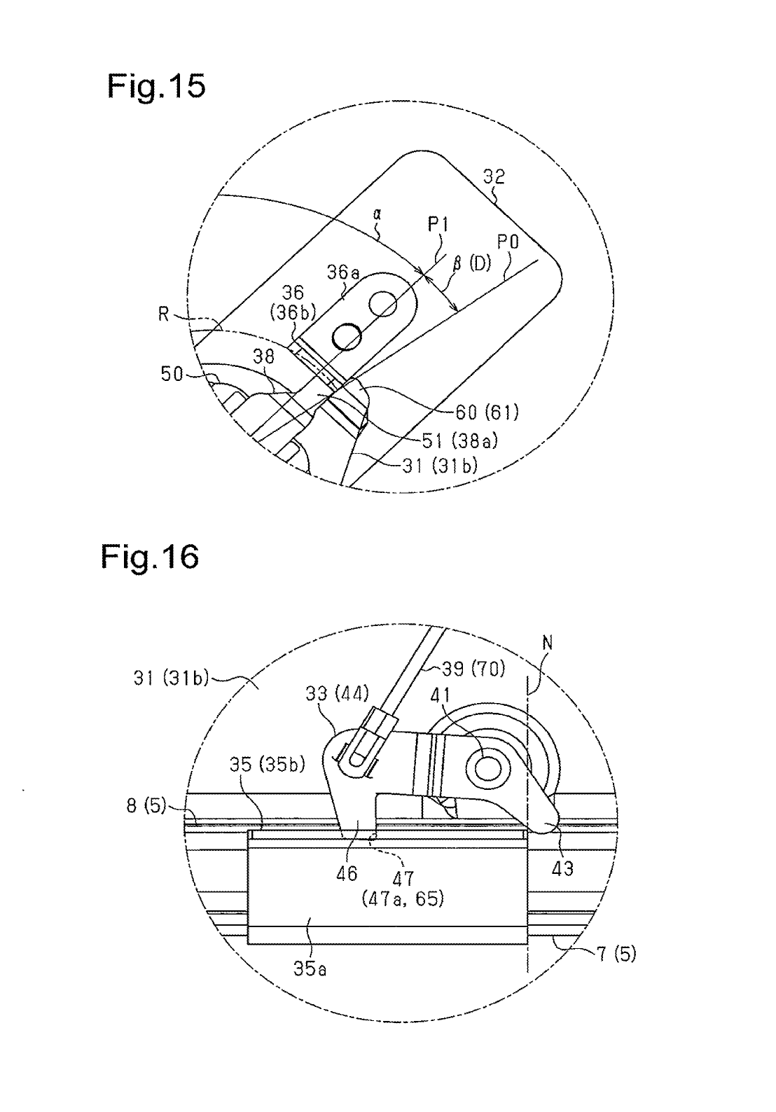

More specifically, as shown in FIG. 15, in the vehicle seat device 30 of the present embodiment, when the seatback 3 is tilted further rearward than the rearward tilt limit position P1, the second engagement member 36 blocks entry of (the locking portion 51 of) the slider 38 into the movement path R of the second engagement member 36.

Specifically, the second engagement member 36 of the present embodiment is configured such that, when the engagement portion 36b is arranged at a position at which the locking portion 51 of the slider 38 enters the movement path R based on the urging force of the torsion coil spring 57, the locking portion 51 of the slider 38 engages with the engagement portion 36b in a state substantially perpendicular to the flat-plate shape of the engagement portion 36b, which intersects with the longitudinal direction of the upper bracket 32. The vehicle seat device 30 of the present embodiment is configured such that sliding of the slider 38, which accompanies pulling up of the coupling rod 39 connected to the second longitudinal end 38b is restricted.

Further, in the present embodiment, a tilt region of the seatback 3 in which the slider 38 is prevented from entering the movement path R of the second engagement member 36 is defined as a tilt region β. When the seatback 3 is in the tilt region β, that is, when the seatback 3 is tilted rearward beyond the restriction range (the tilt region α), which is defined by the rearward tilt limit position P1, the pivoted attitude of the pivot link 33, which engages with the first engagement member 35, is maintained.

That is, as described above, the pivot link 33 of the present embodiment pivots counterclockwise as viewed in FIG. 7 while pulling down the coupling rod 39, and the second engagement protrusion 46, which is provided at the coupling portion 44 coupled to the coupling rod 39, is inserted in the slit-shaped elongated hole 47 provided in the first engagement member 35. Accordingly, the pivot link 33 is shifted to the pivoted attitude of engaging with the first engagement member 35. Then, while pushing up the coupling rod 39, the pivot link 33 pivots clockwise as viewed in FIG. 6, and the second engagement protrusion 46 is removed from the elongated hole 47 of the first engagement member 35, so that the pivoted attitude of engaging with the first engagement member 35 is cancelled.

However, as shown in FIG. 15, when (the locking portion 51 of) the slider 38 is prevented from entering the movement path R of the second engagement member 36, the pivoting action of the pivot link 33 that accompanies pushing up of the coupling rod 39 is restricted. The vehicle seat device 30 of the present embodiment is configured such that the pivoted attitude of the pivot link 33, which engages with the first engagement member 35, is thereby maintained.

As shown in FIG. 16, the vehicle seat device 30 of the present embodiment Is configured such that, when the pivoted attitude of the pivot link 33 engaged with the first engagement member 35 is maintained as described above, the pivot link 33 cannot be disengaged from the first engagement member 35.

Specifically, the first engagement member 35 of the present embodiment is configured such that, when the pivoted attitude of the pivot link 33 engaged with the first engagement member 35 is maintained, the second engagement protrusion 46 of the pivot link 33 inserted in the elongated hole 47 engages with a rear end 47a of the elongated hole 47, which extends along the longitudinal direction of the slide rail 5, by the rearward movement of the seat 1. That is, in the present embodiment, the rear end 47a of the elongated hole 47 functions as a restricting engagement portion 65 for restricting the rearward movement of the seat 1 that accompanies disengagement of the pivot link 33 from the first engagement member 35. The seat device 30 according to the present embodiment can restrict the forward and rearward movement range of the seat 1 when the seatback 3 is tilted rearward beyond the restriction range as described above.

Next, operation of the projection preventing device of the seatback 3 configured by the vehicle seat device 30 of the present embodiment as described above will be described.

As shown in FIGS. 2 to 4, in the present embodiment, the coupling rod 39, which has a rigid structure capable of transmitting a pushing force and is arranged between the pivot link 33 and the slider 38, and the torsion coil spring 57, which urges the slider 38 into the movement path R of the second engagement member 36, constitute an interlocking mechanism 70, which interlocks the pivot link 33 and the slider 38 with each other. With this arrangement, the vehicle seat device 30 of the present embodiment restricts, in the rear movement region of the seat 1, the range of the rearward tilting action of the seatback 3 within a range in which the seatback 3 does not project out of the passenger compartment. In the front movement region of the seat 1, the seat device 30 restricts the range of the forward and rearward movement of the seat 1 within a range in which the rearward tilted seatback 3 does not project out of the passenger compartment.

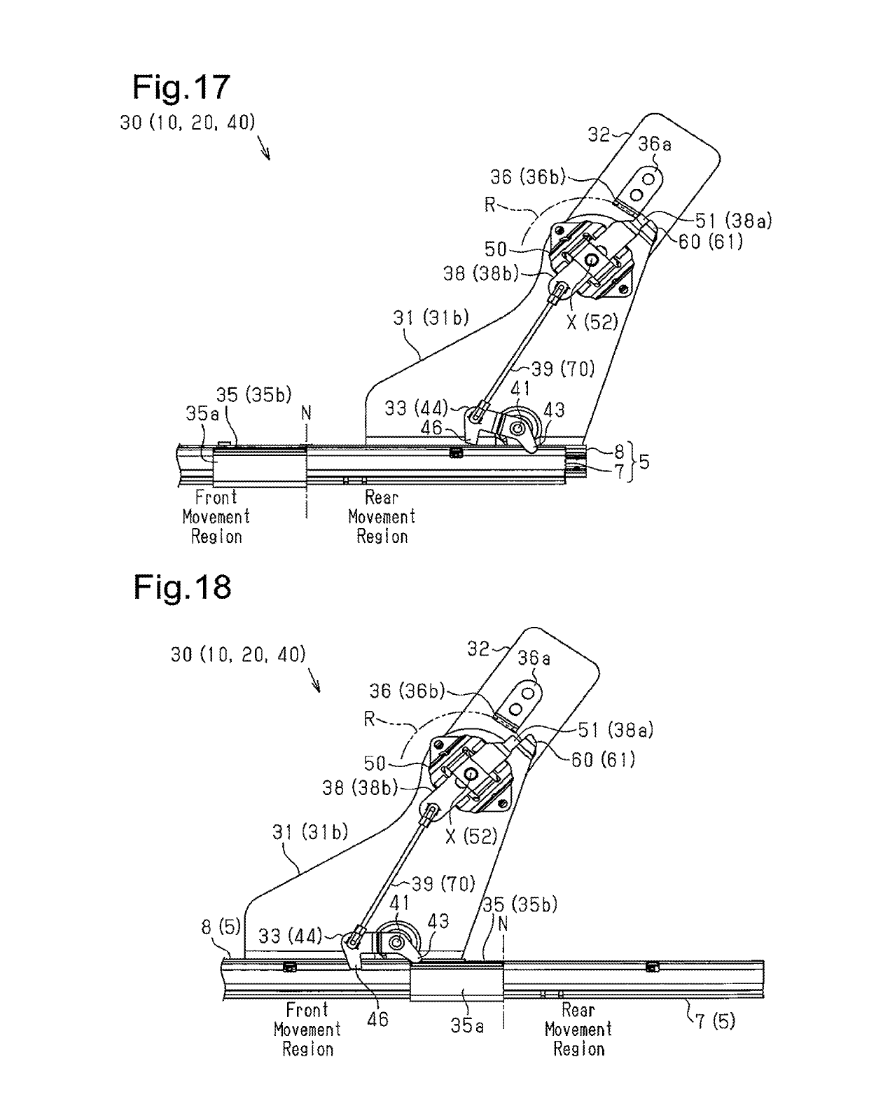

Specifically, as shown in FIG. 17, the vehicle seat device 30 of the present embodiment is configured such that in the rear movement region of the seat 1, in which the pivot link 33 is disengaged from the first engagement member 35 (the first engagement/disengagement state), (the locking portion 51 of) the slider 38 enters the movement path R of the second engagement member 36 based on the urging force of the torsion coil spring 57. As a result, the rearward tilting action of the seatback 3 is restricted to the range up to the rearward tilt limit position P1, in which the second engagement member 36 engages with the slider 38 having entered the movement path R (See FIG. 13).

That is, the rearward tilt limit position P1 is set to a tilt angle at which, even if the seat 1 is in the rear movement region, tilting action within the restriction range defined by the rearward tilt limit position P1, that is, in the tilt region α on the front side of the rearward tilt limit position P1, the seatback 3 does not project out of the passenger compartment. The vehicle seat device 30 of the present embodiment thus allows the seatback 3 to be tilted even in the rear movement region of the seat 1, in which the rearward tilted seatback 3 may project out of the passenger compartment, and is capable of preventing the seatback 3 from projecting out of the passenger compartment due to the rearward tilting action.

Also, as shown in FIG. 18, in the vehicle seat device 30 of the present embodiment, the pivot link 33 engaged with the first engagement member 35 by the forward movement of the seat 1 pulls down the slider 38 via the coupling rod 39, so that the slider 38 is retracted from the movement path R of the second engagement member 36. As a result, the rearward tilting action range of the seatback 3 is enlarged to the maximum rearward tilt position P0, at which the second engagement member 36 engages with the stopper portion 60, which is provided on the lower bracket 31 (see FIG. 14).

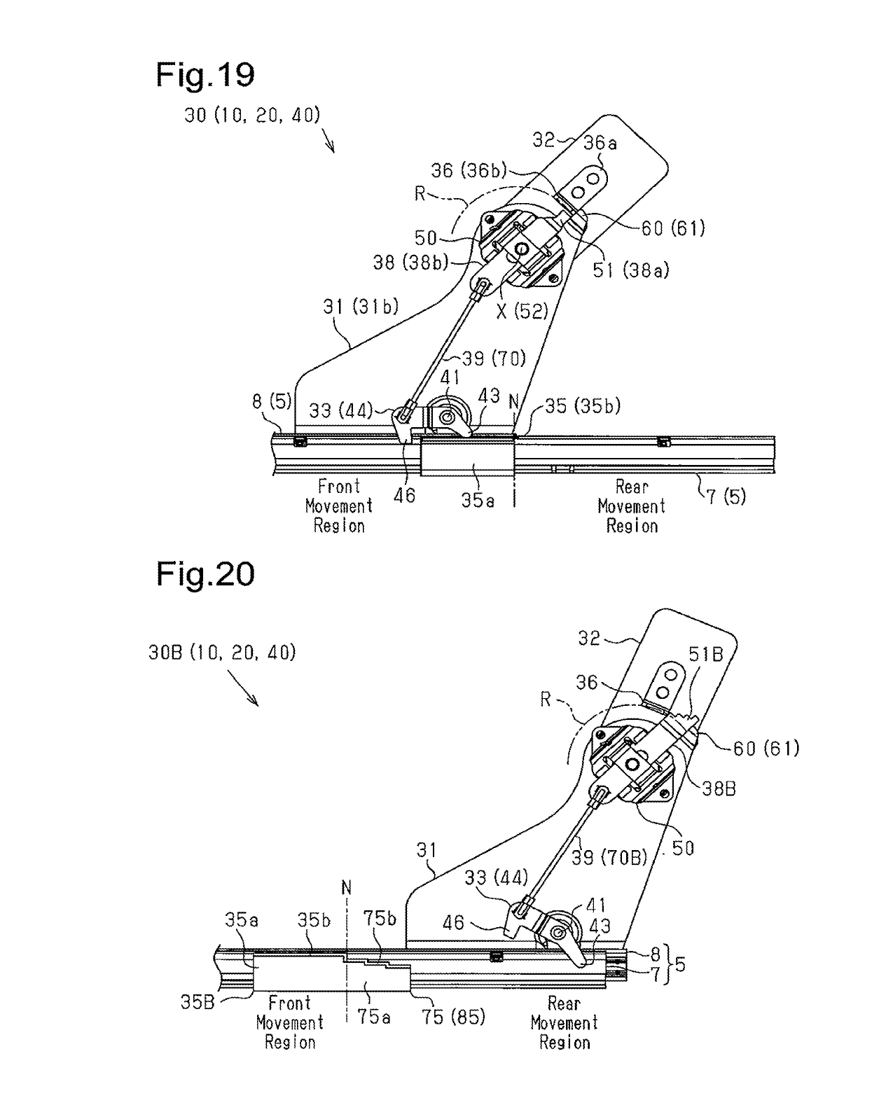

Further, as shown in FIG. 19, even in the state in which the pivot link 33 engages with the first engagement member 35 (the second engagement/disengagement state) as described above, the vehicle seat device 30 of the present embodiment allows the seat 1 to move forward and rearward. When the seatback 3 is tilted rearward beyond the restriction range defined by the rearward tilt limit position P1, the slider 38 is prevented from entering the movement path R of the second engagement member 36 (See FIG. 15). As a result, the pivoted attitude of the pivot link 33 engaged with the first engagement member 35 is maintained, so that the rearward movement of the seat 1 that accompanies disengagement of the pivot link 33 is restricted (See FIG. 16).

That is, in the vehicle seat device 30 of the present embodiment, the front movement region of the seat 1, in which the pivot link 33 engages with the first engagement member 35, is defined such that, even if the seat 1 is moved rearward with the seatback 3 tilted to the maximum rearward tilt position P0, the rearward tilted seatback 3 does not project out of the passenger compartment. The vehicle seat device 30 of the present embodiment is capable of preventing the rearward tilted seatback 3 from being caused to project out of the passenger compartment by the rearward movement of the seat 1, while allowing the forward and rearward moving operation of the seat 1, even in the tilt region β, in which the tilt angle of the seatback 3 may cause the seatback 3 to project out of the passenger compartment.

The present embodiment achieves the following advantages.

(1) The vehicle seat device 30 includes the pivot link 33, which moves forward and rearward integrally with the seat 1 supported on the slide rails 5, and the first engagement member 35, which engages with and disengages from the pivot link 33 based on the forward and rearward movements of the seat 1. Further, the vehicle seat device 30 includes the second engagement member 36, which operates integrally with the seatback 3, the slider 38, which is capable of entering and exiting the movement path R, which is taken by the second engagement member 36 when the seatback 3 is tilted, and the interlocking mechanism 70, which interlocks the pivot link 33 and the slider 38 with each other. Further, the slider 38 restricts the rearward tilting action range of the seatback 3 by entering the movement path R of the second engagement member 36. In the rear movement region of the seat 1, in which the pivot link 33 is disengaged from the first engagement member 35, the interlocking mechanism 70 causes the slider 38 to enter the movement path R of the second engagement member 36. In the front movement region of the seat 1, in which the pivot link 33 engages with the first engagement member 35, the interlocking mechanism 70 causes the slider 38 to exit the movement path R of the second engagement member 36.

With the above-described configuration, in the rear movement region of the seat 1, in which the rearward tilted seatback 3 may project out of the passenger compartment, it is possible to prevent the seatback 3 from projecting out of the passenger compartment due to the rearward tilting action. Even in such a rear movement region of the seat 1, the rearward tilting of the seatback 3 is permitted within the restriction range, that is, within the tilt region α, which is in front of the rearward tilt limit position P1, at which the second engagement member 36 engages with the slider 38 that has entered the movement path R. As a result, for example, even when adjusting the tilt angle within a range in which the seatback 3 does not project out of the passenger compartment, it is possible to eliminate complications found in the prior art, such as the necessity of moving the seat 1 forward in advance. This ensures the convenience.

(2) When the seatback 3 is tilted rearward beyond the restriction range (tilt region α) defined by the rearward tilt limit position P1, that is, when the seatback 3 is located in the tilt region β, which is rearward of the rearward tilt limit position P1, the second engagement member 36 prevents the slider 38 from entering the movement path R. In addition, when the slider 38 is prevented from entering the movement path R in this way, the interlocking mechanism 70 maintains the pivoted attitude of the pivot link 33, which engages with the first engagement member 35. When the pivoted attitude of the pivot link 33, which engages with the first engagement member 35, is maintained, the pivot link 33 cannot be disengaged from the engagement member 35.

With the above-described configuration, when the tilt angle of the seatback 3 is in the tilt region β, in which the seatback 3 may project out of the passenger compartment, the tilted seatback 3 will not be caused to project out of the passenger compartment by the rearward movement of the seat 1. Even in the tilt region β of the seatback 3, the forward and rearward moving operation of the seat 1 is permitted in the front movement region of the seat 1, in which the pivot link 33 engages with the first engagement member 35. As a result, for example, even when adjusting the position of the seat 1 in the front-rear direction within a range in which the tilted seatback 3 does not project out of the passenger compartment, it is possible to eliminate complications found in the prior art, such as the necessity of raising the seatback 3 forward in advance. This ensures the convenience.

(3) The first engagement member 35 has the elongated hole 47, which extends in the extending direction of the slide rail 5. Further, the pivot link 33 includes the second engagement protrusion 46, which is inserted into the elongated hole 47 when the pivot link 33 engages with the first engagement member 35 and pivoted. The first engagement member 35 of the present embodiment is configured such that, when the pivoted attitude of the pivot link 33 engaged with the first engagement member 35 is maintained by the interlocking mechanism 70, the second engagement protrusion 46 of the pivot link 33 inserted into the elongated hole 47 engages with the rear end 47a of the elongated hole 47 by the rearward movement of the seat 1.

With the above configuration, the rear end 47a of the elongated hole 47, which is provided in the first engagement member 35, functions as the restricting engagement portion 65, which restricts the rearward movement of the seat 1 that accompanies disengagement of the pivot link 33, which engages with the first engagement member 35. As a result, by allowing operation for moving the seat 1 forward and rearward only in the front movement region, where the pivot link 33 engages with the first engagement member 35, the rearward tilted seatback 3 will not be caused to project out of the passenger compartment space by the rearward movement of the tilted seatback 3.

(4) The slider 38 is provided on the lower bracket 31, which functions as a first support member that moves forward and rearward integrally with the seat 1 by being supported on the slide rail 5. The second engagement member 36 is provided on the upper bracket 32, which functions as a second support member that is coupled to the lower bracket 31 so as to be rotational relative to the lower bracket 31. The lower bracket 31 is provided with the stopper portion 60, which defines the maximum rearward tilt position P0 of the seatback 3 by being engaged with the second engagement member 36. Then, the slider 38 enters the movement path R in a state in which the rear portion is supported by the stopper portion 60.

With the above-described configuration, the stopper portion 60 functions as the support portion 61, which supports the slider 38, which has entered the movement path R of the second engagement member 36, from behind. This stably maintains the attitude of entry of the slider 38 against the pushing force of the second engagement member 36, which engages with the slider 38. In addition, based on the insertion width D of (the locking portion 51 of) the slider 38, which is sandwiched between the stopper portion 60 and the second engagement member 36, it is possible to easily set the adjustable tilt angle of the seatback 3, which is reduced by the entry of the slider 38 into the movement path R of the second engagement member 36.

(5) The slider 38 reciprocates on the straight line L, which passes through the tilt axis X of the seatback 3. This efficiently restricts the rearward movement of the second engagement member 36, which contacts the locking portion 51 of the slider 38 in the movement path R. As a result, it is possible to stably restrict the rearward tilting action range of the seatback 3.

(6) The interlocking mechanism 70 includes the coupling rod 39, which has a rigid structure capable of transmitting the pushing force and is arranged between the pivot link 33 and the slider 38. That is, by interposing the coupling rod 39, the drive force is efficiently transmitted between the slider 38 and the pivot link 33 for both entry and exit of the slider 38 with respect to the moving path R of the second engagement member 36. This allows the slider 38 and the pivot link 33 to be smoothly interlocked with each other with a simple configuration.

### Second Embodiment

A vehicle seat device 30B according to a second embodiment will now be described with reference to the drawings. For illustrative purposes, like or the same reference numerals are given to those components that are like or the same as the corresponding components of the first embodiment and detailed explanations are omitted.

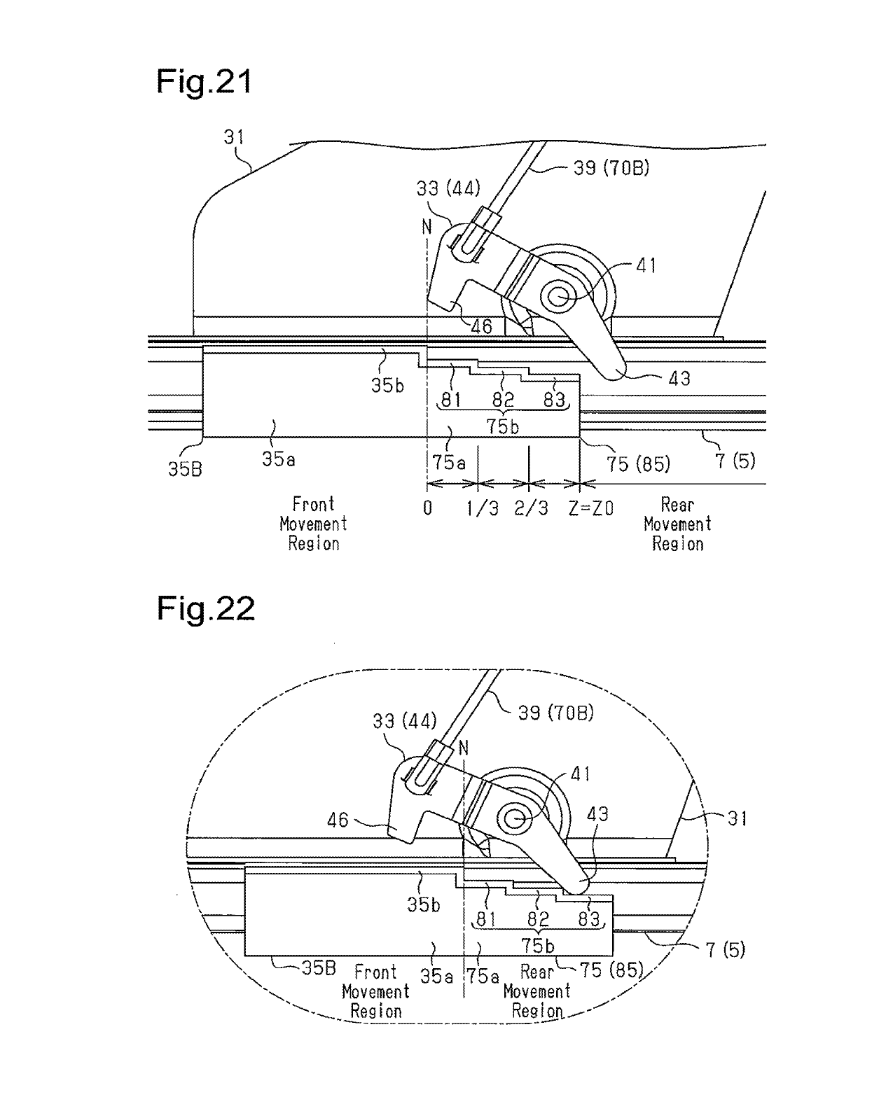

As shown in FIGS. 20 and 21, the vehicle seat device 30B includes a third engagement member 75. The third engagement member 75 engages with the pivot link 33 at a position behind the engagement/disengagement position N, where the rear end of a first engagement member 35B is arranged, that is, in the rear movement region of the seat 1, in which the pivot link 33 is disengaged from the first engagement member 35B.

More specifically, the third engagement member 75 of the present embodiment is integrally formed with the first engagement member 35B, so that the third engagement member 75 is arranged in a rear movement region adjacent to the rear end of the first engagement member 35B (the engagement/disengagement position N). Similarly to the first engagement member 35B, the third engagement member 75 includes a vertical plate portion 75a, which is arranged to be upright on the side of the slide rail 5. Further, the third engagement member 75 also has a flange-shaped lateral plate portion 75b extending from the upper end portion of the vertical plate portion 75a toward the outside in the width direction of the slide rail 5 (toward the viewer of the drawing of FIG. 21). That is, the third engagement member 75 is also configured such that the first engagement protrusion 43 of the pivot link 33 engages with and disengages from the lateral plate portion 75b, which constitutes the engagement portion of the third engagement member 75, based on the forward and rearward movement of the seat 1. In the third engagement member 75 of the present embodiment, the lateral plate portion 75b has a shape of stairs in which the height (the position in the vertical direction in FIG. 21) is gradually decreased from the front to the rear (from the left side to the right side in FIG. 21).

Specifically, in the third engagement member 75 of the present embodiment, the lateral plate portion 75b has three steps of engagement step portions 81 to 83 provided at substantially equal intervals along the extending direction of the slide rail 5. Further, in the third engagement member 75, the first engagement step portion 81 arranged at the front-most side is located at a position lower than the lateral plate portion 35b of the first engagement member 35B, which is located on the front side of the first engagement step portion 81. The second engagement step portion 82 positioned behind the first engagement step portion 81 is located at a position lower than the first engagement step portion 81, and the third engagement step portion 83 positioned behind the second engagement step portion 82 is located at a position lower than the second engagement step portion 82.

That is, as shown in FIGS. 21 to 25, in the vehicle seat device 30B of the present embodiment, the pivot link 33 as the first movable member moves forward and rearward together with the seat 1 in the rear movement region, so that the first engagement protrusion 43 sequentially gets onto and engages with the engagement step portions 81 to 83 of the third engagement member 75 and the lateral plate portion 35b of the first engagement member 35B.

Specifically, as shown in FIG. 21, the pivot link 33 is in a state disengaged from the third engagement member 75 when a rearward movement amount Z of the seat 1 from the engagement/disengagement position N, at which the pivot link 33 engages with and disengages from the lateral plate portion 35b of the first engagement member 35B, is greater than the extension length Z0 of the third engagement member 75 in the extending direction of the slide rail 5 (Z>Z0).

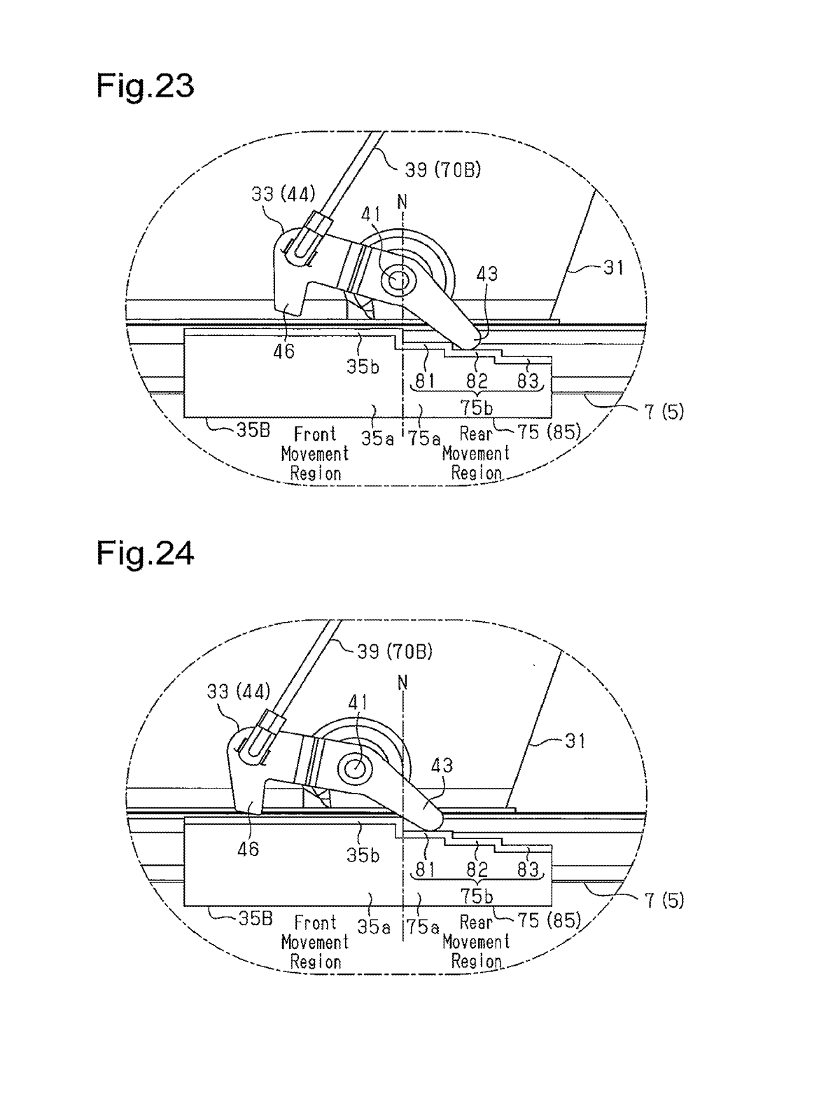

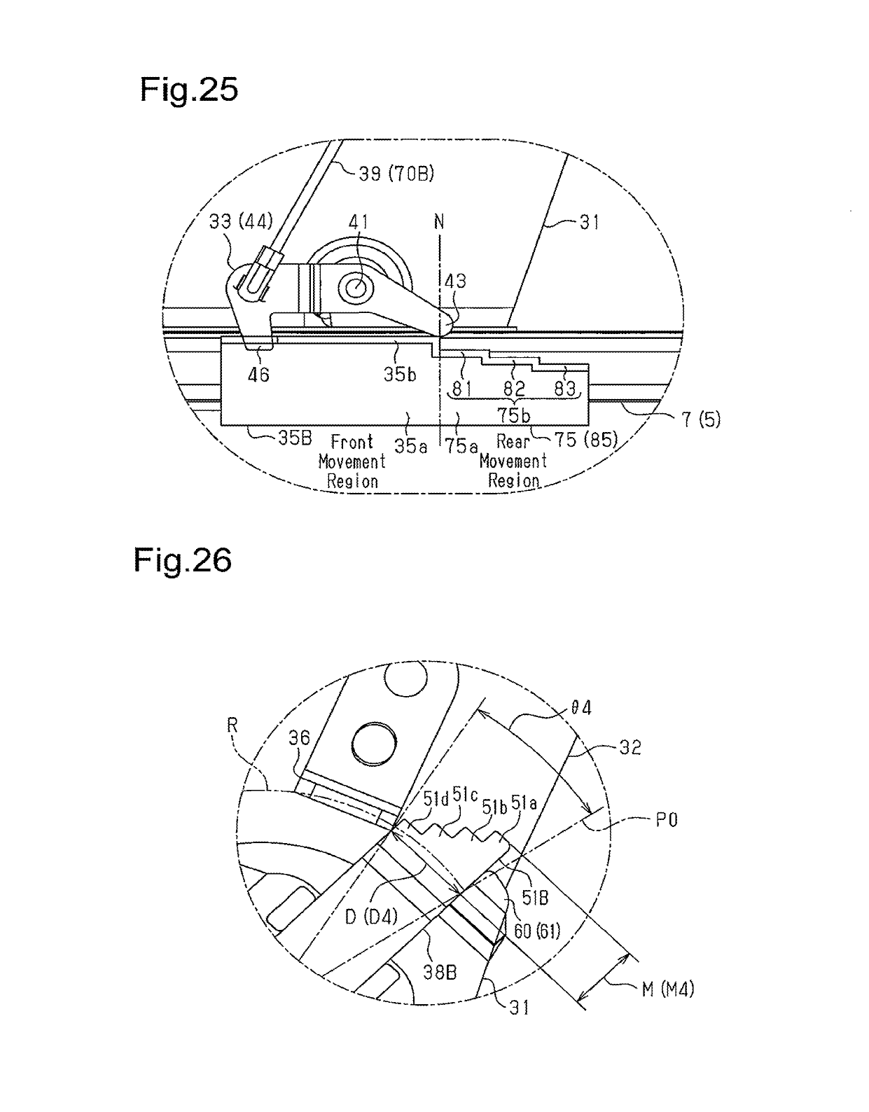

Further, as shown in FIG. 22, when the forward movement of the seat 1 causes the rearward movement amount Z thereof to become less than or equal to the extension length Z0 of the third engagement member 75 (Z≦Z0), the first engagement protrusion 43 of the pivot link 33 gets onto and engages with the third engagement step portion 83 of the third engagement member 75. Further, as shown in FIGS. 23 and 24, the first engagement protrusion 43 of the pivot link 33 engages with the second engagement step portion 82 when the rearward movement amount Z of the seat 1 becomes substantially less than or equal to ⅔ of the extension length Z0 of the third engagement member 75. The first engagement protrusion 43 of the pivot link 33 engages with the first engagement step portion 81 when the rearward movement amount Z of the seat 1 becomes substantially less than or equal to ⅓ of the extension length Z0 of the third engagement member 75. As shown in FIG. 25, the vehicle seat device 30B of the present embodiment is configured such that when the rearward movement amount Z is 0, that is, when the seat 1 moves forward to the front movement region beyond the engagement/disengagement position N, the first engagement protrusion 43 of the pivot link 33 engages with the lateral plate portion 35b of the first engagement member 35B.

At this time, as shown in FIGS. 21 to 25, the pivot link 33 pivots counterclockwise in a stepwise manner on the basis of the height differences of the engagement step portions 81 to 83 of the third engagement member 75, to which the first engagement protrusion 43 is engaged, and the lateral plate portion 35b of the first engagement member 35B. Further, when the seat 1 moves rearward in the rear movement region in a state in which the pivot link 33 engages with the third engagement member 75, the pivot link 33 pivots clockwise as viewed in the drawing in a stepwise manner. The vehicle seat device 30B of the present embodiment is configured to gradually change the actuation amount of the slider 38B as the second movable member, which enters the movement path R of the second engagement member 36.

That is, in the vehicle seat device 30B of the present embodiment, the pivot link 33 pivoting counterclockwise as viewed in FIGS. 21 to 25 pulls down the coupling rod 39 connected to the coupling portion 44 so that the slider 38B, which is coupled to the coupling portion 44 via the coupling rod 39, exits the movement path R. Further, in each drawing, the pivot link 33 pivoting clockwise pushes up (pulls up) the coupling rod 39 connected to the coupling portion 44, so that the slider 38B, which is connected to the coupling portion 44 via the coupling rod 39, enters the movement path R of the second engagement member 36. Furthermore, in the vehicle seat device 30B of the present embodiment, the pivoted attitude of the pivot link 33 is changed discretely in accordance with the position at which the pivot link 33 engages with the third engagement member 75. Specifically, the third engagement member 75 functions as a gradual-change engagement portion. On the basis of the differences in heights of the three engagement step portions 81 to 83 and the lateral plate portion 35b of the first engagement member 35B, the third engagement member 75 changes the pivoted attitude of the pivot link 33 in four stages from the engaging attitude with respect to the first engagement member 35B shown in FIG. 25 to the completely disengaged attitude as shown in FIG. 21. Accordingly, the vehicle seat device 30B of the present embodiment includes an interlocking mechanism 70B, which incorporates a gradual-change mechanism 85. The gradual-change mechanism 85 increases the actuation amount of the slider 38B entering the movement path R of the second engagement member 36 in accordance with increase in the rearward movement amount Z of the seat 1, which has moved into the rear movement region.

Further, as shown in FIGS. 26 to 30, the slider 38B of the present embodiment has a locking portion 51B, which tapers toward the distal end. Specifically, the locking portion 51B includes a proximal end portion having a width substantially equal to the width of the main body of the slider 38B. The locking portion 51B also has a shape of stairs in which four steps of insertion portions 51a to 51d, which are formed by cutting out the end in the width direction from the front side (upper left side in each drawing). The slider 38B of the present embodiment is configured so as to narrow the rearward tilting action range of the seatback 3 in accordance with increase in an actuation amount M of entry into the movement path R of the second engagement member 36.

More specifically, similarly to the slider 38 in the first embodiment, the slider 38B of the present embodiment is also configured such that the locking portion 51B enters the movement path R of the second engagement member 36 in a state in which the rear side of the slider 38B is supported by the stopper portion 60 of the seatback 3 provided on the lower bracket 31. The slider 38B of the present embodiment is configured such that, as the actuation amount M of entry into the movement path R of the second engagement member 36 increases, the insertion width D of the portion arranged in the movement path R increases based on the stepped shape of the locking portion 51B tapering toward the distal end.

Specifically, as shown in FIG. 26, the slider 38B of the present embodiment is configured such that, when the fourth insertion portion 51d, which is located at the proximal end of the locking portion 51B, is arranged in the movement path R of the second engagement member 36, the rearward tilting action range of the seatback 3 is narrowest. At this time, the pivot link 33, which functions as the first movable member, is disengaged from the third engagement member 75 as shown in FIGS. 20 and 21.

That is, as shown in FIG. 26, the gradual-change mechanism 85 of the present embodiment is configured such that, when the rearward movement amount Z of the seat 1 in the rear movement region is greater than the extension length Z0 of the third engagement member 75 (see FIG. 21, Z>Z0), the actuation amount M of the slider 38B entering the movement path R of the second engagement member 36 becomes the maximum (M=M4). Then, when the fourth insertion portion 51d arranged in the movement path R is sandwiched between the second engagement member 36 and the stopper portion 60, the slider 38B of the present embodiment narrows the rearward tilting action range of the seatback 3 by a predetermined angle θ4 corresponding to the insertion width D4 of the fourth insertion portion 51d in front of the maximum rearward tilt position P0 defined by the stopper portion 60. In the present embodiment, the limit position at which the seatback 3 can be tilted rearward in this state is a position substantially equal to the rearward tilt limit position P1 in the first embodiment (see FIG. 13).

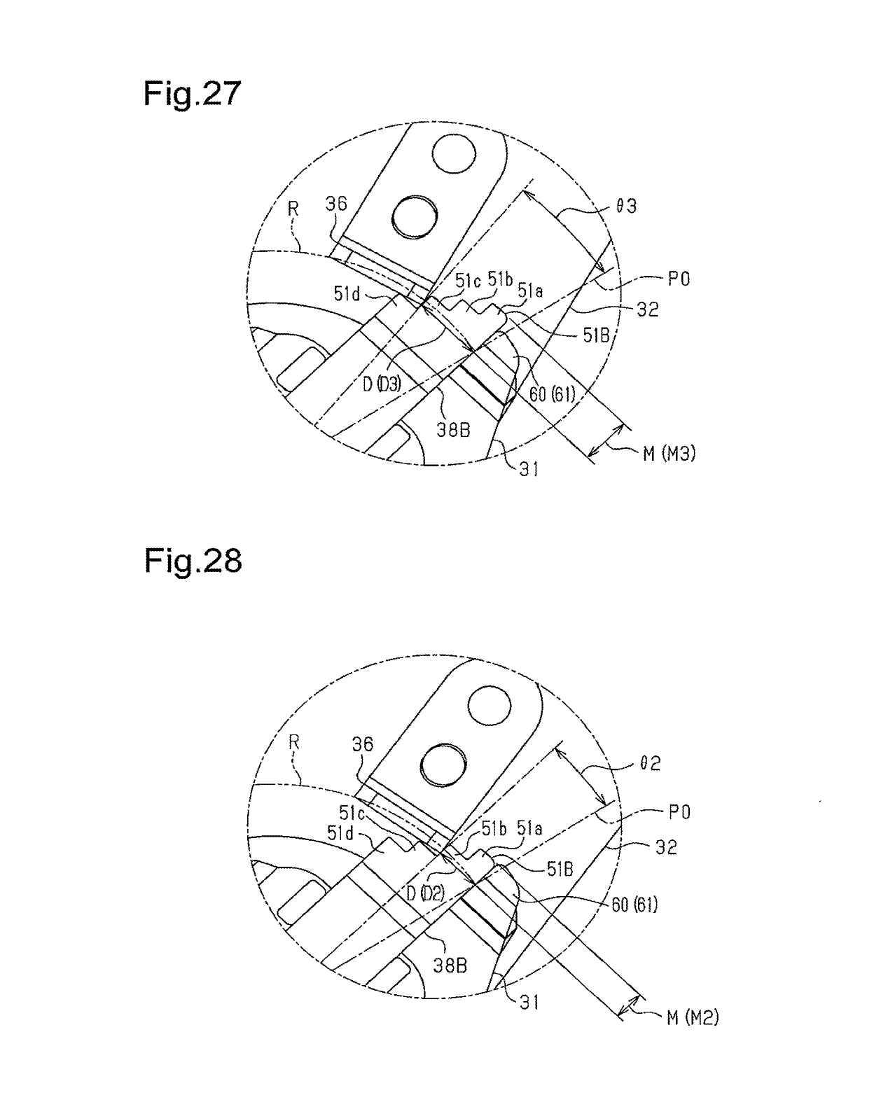

Further, as shown in FIGS. 22 and 27, the slider 38B of the present embodiment is configured such that when the pivot link 33 engages with the third engagement step portion 83 of the third engagement member 75, the third insertion portion 51c provided on the distal side of the fourth insertion portion 51d is arranged in the movement path R of the second engagement member 36. In this case, the actuation amount M3 of the slider 38 B and the insertion width D3 of the third insertion portion 51c are respectively smaller than the actuation amount M4 of the slider 38B and the insertion width D4 of the fourth insertion portion 51d (M3<M4, D3<D4) in the case in which the fourth insertion portion 51d is arranged in the movement path R of the second engagement member 36. Then, when the third insertion portion 51c is sandwiched between the second engagement member 36 and the stopper portion 60, the slider 38B of the present embodiment narrows the rearward tilting action range of the seatback 3 by a predetermined angle θ3 corresponding to the insertion width D3 of the third insertion portion 51c in front of the maximum rearward tilt position P0 defined by the stopper portion 60.

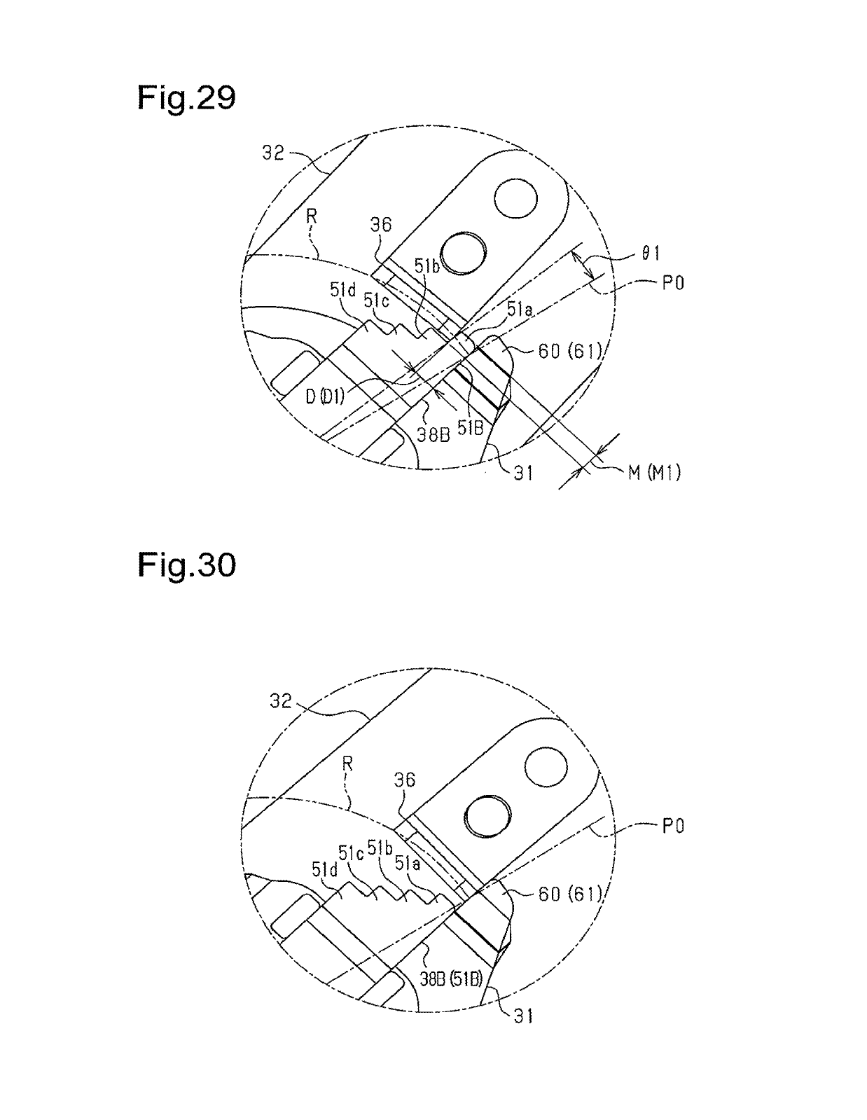

Further, as shown in FIGS. 23 and 28, when the pivot link 33 engages with the second engagement step portion 82 of the third engagement member 75, the second insertion portion 51b, which is provided on the distal side of the third insertion portion 51c, is arranged in the movement path R of the second engagement member 36. Also, as shown in FIGS. 24 and 29, when the pivot link 33 engages with the first engagement step portion 81 of the third engagement member 75, the first insertion portion 51a, which is provided on the distal side of the second insertion portion 51b, is arranged in the movement path R of the second engagement member 36. As shown in FIGS. 28 and 29, the slider 38B of the present embodiment is configured to narrow the rearward tilting action range of the seatback 3 in the forward direction with respect to the maximum rearward tilt position P0 by a predetermined angle θ2 corresponding to the insertion width D2 of the second insertion portion 51b sandwiched between the second engagement member 36 and the stopper 60 or by a predetermined angle θ1 corresponding to the insertion width D1 of the first insertion portion 51a sandwiched between the second engagement member 36 and the stopper 60.

The actuation amount M2 of the slider 38B and the insertion width D2 of the second insertion portion 51b in the case in which the second insertion portion 51b is arranged in the movement path R of the second engagement member 36 are respectively smaller than the actuation amount M3 of the slider 38B and the insertion width D3 of the third insertion portion 51c in the case in which the third insertion portion 51c is arranged in the movement path R of the second engagement member 36 (M2<M3, D2<D3). Also, the actuation amount M1 of the slider 38B and the insertion width D1 of the first insertion portion 51a in the case in which the first insertion portion 51a is arranged in the movement path R of the second engagement member 36 are respectively smaller than the actuation amount M2 of the slider 38B and the insertion width D2 of the second insertion portion 51b in the case in which the second insertion portion 51b is arranged in the movement path R of the second engagement member 36 (M1<M2, D1<D2).

As shown in FIGS. 25, 30, and 31, the gradual-change mechanism 85 of the present embodiment is configured such that the actuation amount M of the slider 38B entering the movement path R of the second engagement member 36 becomes zero (M=0) in a state in which the pivot link 33 engages with the first engagement member 35B, that is, in a state in which the seat 1 has moved to the front movement region beyond the engagement/disengagement position N. That is, at this time, the slider 38B has exited the movement path R of the second engagement member 36. Then, the vehicle seat device 30B of the present embodiment is configured such that the rearward tilting action range of the seatback 3 is expanded to the maximum rearward tilt position P0, at which the second engagement member 36 engages with the stopper section 60.

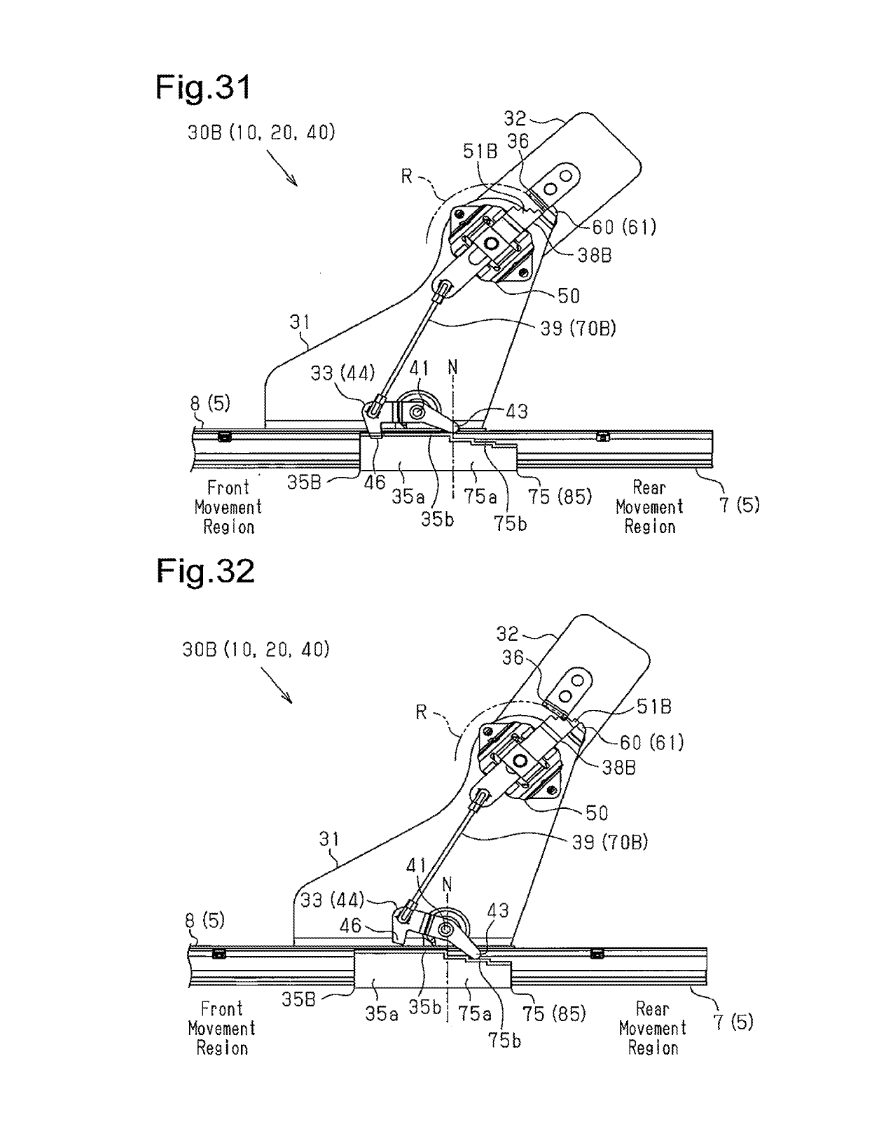

That is, as shown in FIGS. 30 and 31, in the vehicle seat device 30B of the present embodiment, the seatback 3 can be tilted to the maximum rearward tilt position P0 in the front movement region of the seat 1 (see FIG. 21, Z=0), at which the pivot link 33 engages with the first engagement member 35B. Further, as shown in FIG. 32, in a state in which the pivot link 33 engages with the third engagement member 75 provided adjacent to the first engagement member 35B in the rear movement region of the seat 1 (see FIG. 21, 0<Z≦Z0), the rearward tilting action range of the seatback 3 gradually narrows in accordance with increase in the rearward movement amount Z (see FIGS. 27 to 29, P0-θ1 to θ3). As shown in FIG. 20, in a state in which the pivot link 33 is disengaged from the third engagement member 75 by the rearward movement of the seat 1 (see FIG. 21, Z>Z0), the rearward tilting action range of the seatback 3 is narrowed to a position substantially equal to the rearward tilt limit position P1 in the first embodiment (see FIG. 26, P1≈P0−θ4).

The present embodiment achieves the following advantages.

(1) The interlocking mechanism 70B includes the gradual-change mechanism 85, which increases the actuation amount M of the slider 38B entering the movement path R of the second engagement member 36 in accordance with increase in the rearward movement amount Z of the seat 1, which is in the rear movement region. The slider 38B is configured so as to narrow the rearward tilting action range of the seatback 3 in accordance with increase in an actuation amount M of entry into the movement path R of the second engagement member 36.

According to the above configuration, in the rear movement region of the seat 1, where the rearward tilted seatback 3 may project out of the passenger compartment, the rearward tilting action of the seatback 3 is permitted to the maximum extent corresponding to the movement position of the seat 1 while preventing the seatback 3 from being caused to project out of the passenger compartment by the rearward tilting action. This makes it possible to maximize the enlarging effect of the legroom by the rearward movement of the seat 1 and the enlarging effect of the space above the seat by the rearward tilting action of the seatback 3. As a result, it is possible to further improve the convenience of the occupant.

(2) The slider 38B has the locking portion 51B, which tapers in a stepwise manner. Then, with the rear portion supported by the stopper portion 60 of the seatback 3 provided in the lower bracket 31, the locking portion 51B enters the movement path R of the second engagement member 36.

With above described configuration, as the actuation amount M of entry into the movement path R of the second engagement member 36 increases, the insertion width D of the portion arranged in the movement path R increases based on the stepped shape of the locking portion 51B tapering toward the distal end. As a result, the rearward tilting action range of the seatback 3 can be narrowed according to increase in the actuation amount M of entry into the movement path R of the second engagement member 36.

In addition, the engagement of the second engagement member 36 with the stepped shape of the locking portion 51B efficiently restricts the rearward movement of the second engagement member 36, which abuts against the locking portion 51B. As a result, it is possible to stably restrict the rearward tilting action range of the seatback 3.

(3) The vehicle seat device 30B includes the third engagement member 75, which is provided adjacent to the first engagement member 35B and in the rear movement region of the seat 1. Further, the third engagement member 75 has the lateral plate portion 75b, which engages with and disengages from (the first engagement protrusion 43 of) the pivot link 33, which functions as the first movable member, based on the forward and rearward movement of the seat 1. The lateral plate portion 75b has a shape of stairs in which the height is gradually increased from the front to the rear.

With the above configuration, the pivot link 33, which engages with the lateral plate portion 35b of the third engagement member 75, rotates stepwise based on the differences in the heights of the respective engagement step portions (81 to 83) in a shape of stairs of the lateral plate portion 35b. That is, the third engagement member 75 functions as a gradual-change engagement portion, which increases the actuation amount M of the pivot link 33, which functions as the first movable member, in accordance with an increase in the rearward movement amount Z of the seat 1. This forms, with a simple structure, the gradual-change mechanism 85, which increases the actuation amount M of the slider 38B entering the movement path R of the second engagement member 36 in accordance with increase in the rearward movement amount Z of the seat 1 in the rear movement region.

Each of the above illustrated embodiments may be modified as follows.

In each of the above-described embodiments, the slider 38, which reciprocates on the straight line L passing through the tilt axis X of the seatback 3, forms the second movable member, which advances and retreats with respect to the movement path R, which is taken by the second engagement member 36 when the seatback 3 is tilted. However, the present invention is not limited to this, and the configuration of the slider 38 such as its shape, arrangement, and supporting structure may be arbitrarily changed. Further, the configuration of the second engagement member 36 may also be arbitrarily changed.

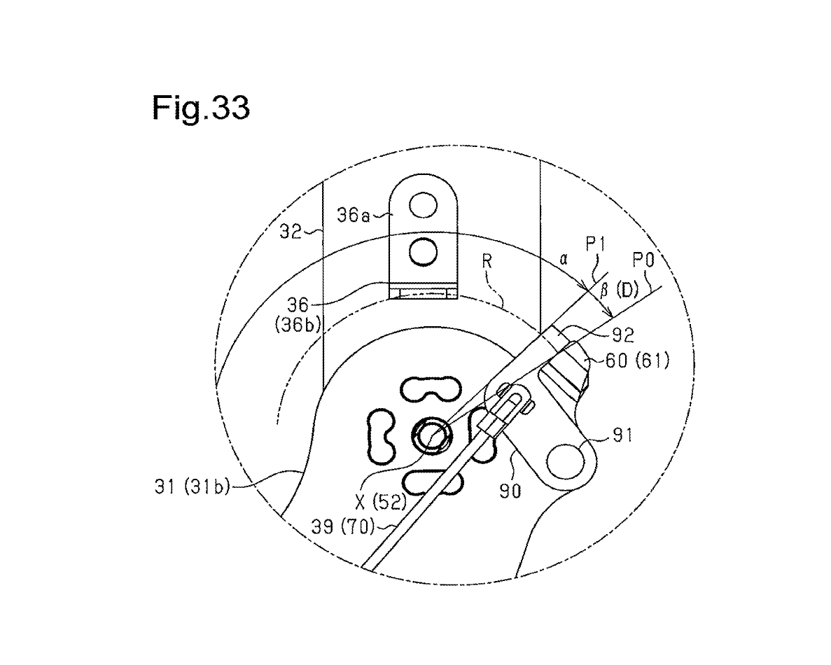

Further, the second movable member may be configured by a configuration other than the slider 38. For example, as shown in FIG. 33, a pivot link 90 may be provided in the vicinity of the upper end of (the vertical wall portion 31b of) the lower bracket 31. Further, the pivot link 90 may be used as the second movable member.

Specifically, the pivot link 90 is rotationally supported at its proximal end by a spindle 91 provided on the lower bracket 31. Further, the pivot link 90 has a locking portion 92 protruding in a hook shape (L-shape) from the distal end. The pivot link 90 is pivoted clockwise as viewed in FIG. 33 such that the locking portion 92 enters the movement path R of the second engagement member 36 while contacting the stopper portion 60 at the upper end of the lower bracket 31. In this example, the pivot link 90 is urged in the direction of entering the movement path R by an urging member that is not shown in the drawing (for example, a torsion coil spring fitted in the spindle 91). When pulled down by the coupling rod 39 connected to the distal end, the pivot link 90 pivots counterclockwise as viewed in the drawing, so that the locking portion 92 exits the movement path R of the second engagement member 36.

With this configuration also, the same advantages as the above-illustrated embodiments are achieved. In the case of using such a pivot link, its shape and arrangement may be arbitrarily changed. For example, a configuration may be employed in which a pressure angle capable of maintaining the attitude of entry with respect to its movement path R is defined between the pivot link and second engagement member 36. This allows the support portion 61 to be omitted.

Further, the configuration of the pivot link 33, which functions as the first movable member, may be arbitrarily changed, for example, in its shape, arrangement, and support structure. Likewise, the first engagement member 35, which engages with and disengages from the pivot link 33, may be arbitrarily changed, for example, in the configuration of the restricting engagement portion 65. Also, for example, a configuration other than the pivot link 33 such as a slider may be employed as the first movable member.

In each of the above-illustrated embodiments, in the present embodiment, the coupling rod 39, which has a rigid structure capable of transmitting a pushing force and is arranged between the pivot link 33 and the slider 38, and the torsion coil spring 57, which urges the slider 38 into the movement path R of the second engagement member 36, constitute an interlocking mechanism 70, which interlocks the pivot link 33 and the slider 38 with each other. However, the present invention is not limited to this, and the configuration of the interlocking mechanism 70 may be arbitrarily changed.

The urging member may be arbitrarily changed. For example, a spring member other than the torsion coil spring 57 may be used. Further, the object to receive the urging force does not necessary need to be the slider 38. For example, the pivot link 33 or the coupling rod 39 may be urged. Further, configurations without such an urging member are not excluded.

In addition, it is not always necessary to use a coupling member having a rigid structure such as the coupling rod 39. For example, a coupling member may be provided by combining a link and a wire cable. Also, the urging direction by the urging force may be arbitrarily changed.

In each of the above-illustrated embodiments, the first engagement member 35 is arranged in the front movement region of the seat 1. A state in which the pivot link 33 is disengaged from the first engagement member 35 is defined as the first engagement/disengagement state of the pivot link 33, and a state in which the pivot link 33 engages with the first engagement member 35 is defined as the second engagement/disengagement state of the pivot link 33. When the slider 38 is prevented from entering the movement path R of the second engagement member 36, the engagement/disengagement attitude of the pivot link 33 maintained by the interlocking mechanism 70 is the same as the pivoted attitude of the pivot link 33 when engaged with the first engagement member 35.

However, the present invention is not limited to this, and the engagement/disengagement relationship between the first engagement member 35 and the pivot link 33 caused by the forward and rearward movement of the seat 1 may be configured to be opposite to that in the above-illustrated embodiments. That is, the first engagement member 35 may be provided in the rear movement region of the seat 1. A state in which the pivot link 33 engages with the first engagement member 35 is defined as the first engagement/disengagement state of the pivot link 33, and a state in which the pivot link 33 is disengaged from the first engagement member 35 is defined as the second engagement/disengagement state of the pivot link 33. When the slider 38 is prevented from entering the movement path R of the second engagement member 36, the engagement/disengagement attitude of the pivot link 33 maintained by the interlocking mechanism 70 is the same as the pivoted attitude of the pivot link 33 when disengaged from the first engagement member 35. With this configuration also, the same advantages as the above-illustrated embodiments are achieved.

In the above-illustrated embodiments, the stopper portion 60 provided on the lower bracket 31 functions as the support portion 61. The support portion 61 supports the slider 38, which has entered the movement path R of the second engagement member 36, from behind. However, the present invention is not limited to this, and the support portion 61 may be provided separately from the stopper portion 60. Configurations without the support portion 61 are also not excluded.

The structure for supporting the seat 1 (the seat cushion 2) on the slide rails 5 may be arbitrarily changed. For example, the seat cushion 2 may be directly fixed to the upper rails 8, which are components of the slide rails 5, or may be fixed to the upper rails 8 via support brackets. The lower bracket 31 as the first support member may also function as a support bracket for the seat cushion 2.

In each of the above-illustrated embodiments, the pivot link 33, the slider 38, and the stopper portion 60, which is a component of the support portion 61, are supported on the slide rail 5 to be attached to the lower bracket 31, which is moved integrally forward and rearward with the seat 1. The second engagement member 36 is supported by the upper bracket 32, which is coupled to the lower bracket 31, via the recliner 15. However, the present invention is not limited to this, and the lower bracket 31 and the upper bracket 32 may be coupled to each other to be rotational relative to each other without the recliner 15 in between.

In addition, all or at least one of the first movable member, the second movable member, and the support portion 61 (the pivot link 33, the slider 38, and the stopper portion 60) may be supported by a “support member that moves forward and rearward integrally with the seat 1” other than the lower bracket 31, which tiltably supports the seatback 3 (the upper bracket 32). As this support member, for example, the frame of the seat cushion 2, support brackets, or the like may be employed. Further, the support member may be formed integrally with the upper rail 8, which is a component of the slide rail 5.

Further, as long as the second engagement member 36 can operate integrally with the seatback 3, the position at which the second engagement member 36 is installed is not necessarily the upper bracket 32. The section to which the first engagement member 35 is fixed may also be, for example, the vehicle floor 4 or the like, and the section does not necessarily need to be the lower rail 7 of the slide rail 5.

In the second embodiment, the locking portion 51B of the slider 38B is formed in a stepwise tapered shape having four stages of insertion portions 51a to 51d. However, the present invention is not limited to this, and the number of stages of the stair shape may be less than or more than four. Further, the tapered shape may be, for example, a triangular shape that becomes tapered toward the distal end. Further, even when the second movable member has a configuration other than a slider, the second movable member may have any structure as long as the insertion width D of the portion arranged in the movement path R of the second engagement member 36 increases as the actuation amount M entering the movement path R increases. For example, a configuration may be employed in which, as the actuation amount M entering the movement path R of the second engagement member 36 increases, the contact point with the second movable member on the movement path R is shifted forward.

In the second embodiment, the third engagement member 75, which functions as the gradual-change engagement portion, has the lateral plate portion 75b, which functions as the engagement portion engaged with the pivot link 33. The lateral plate portion 75b has a shape of stairs in which the height is gradually decreased from the front to the rear. The stair shape is provided by the three engagement step portions 81 to 83. However, the present invention is not limited to this, and the number of stages of the stair shape may be less than or more than three. Further, the lateral plate portion 75b, which functions as the engagement portion, may have a slope that is lowered from the front to the rear. Also, in the case in which the first movable member has a configuration other than a pivot link, the gradual-change engagement portion may be modified as long as it increases the actuation amount of the first movable member in accordance with an increase in the amount of rearward movement of the seat.

Next, the technical ideas obtainable from the above embodiments will be described below with their advantages.

(A) A vehicle seat device, wherein the interlocking mechanism includes a coupling member that has a rigid structure capable of transmitting a pushing force and is arranged between the first movable member and the second movable member.

With the above configuration, it is possible to efficiently transmit the drive force between the first movable member and the second movable member for both the entry and exit of the second movable member with respect to the movement path of the second engagement member. This allows the first movable member and the second movable member to be smoothly interlocked with each other with a simple configuration.

(B) The vehicle seat device, wherein the first engagement member is arranged in a front movement region of the seat, and the first engagement/disengagement state is a state in which the first movable member is disengaged from the first engagement member.

(C) The vehicle seat device, wherein the gradual-change engagement portion includes a plurality of engagement step portions as the engagement portion.

With the above configuration, the actuation amount of the first movable member, which engages with the third engagement member, can be changed in stages based on the stair shape provided by the engagement step portions.

(D) The vehicle seat device, wherein the second movable member is arranged on a first support member that is supported on the slide rail and moves forward and rearward integrally with the seat, and the second engagement member is arranged on a second support member that is coupled to the first support member so as to be relatively rotational.

1. A vehicle seat device comprising:
a first movable member, which moves forward and rearward integrally with a seat supported on a slide rail;
a first engagement member, which is engaged with or disengaged from the first movable member based on forward or rearward movement of the seat;
a second engagement member, which operates integrally with a seatback of the seat;
a second movable member, which is capable of approaching and moving away from a movement path that is taken by the second engagement member when the seatback is tilted; and
an interlocking mechanism, which interlocks the first movable member and the second movable member with each other, wherein
the first movable member is configured to be in a first engagement/disengagement state when the seat is in a rear movement region,
the first movable member is configured to be in a second engagement/disengagement state when the seat is in a front movement region,
one of the first engagement/disengagement state and the second engagement/disengagement state is a state in which the first movable member is engaged with the first engagement member,
the other one of the first engagement/disengagement state and the second engagement/disengagement state is a state in which the first movable member is disengaged from the first engagement member,
the second movable member is configured to enter the movement path of the second engagement member to restrict a rearward tilting action range of the seatback,
the interlocking mechanism is configured to cause the second movable member to enter the movement path of the second engagement member when the seat is in the rear movement region, and
the interlocking mechanism is configured to cause the second movable member to exit the movement path of the second engagement member when the seat is in the front movement region.

2. A vehicle seat device comprising:
a first movable member, which moves forward and rearward integrally with a seat supported on a slide rail;
a first engagement member, which is engaged with or disengaged from the first movable member based on forward or rearward movement of the seat;
a second engagement member, which operates integrally with a seatback of the seat;
a second movable member, which is capable of approaching and moving away from a movement path that is taken by the second engagement member when the seatback is tilted; and
an interlocking mechanism, which interlocks the first movable member and the second movable member with each other, wherein
the second movable member is configured to enter the movement path of the second engagement member to define a restriction range of tilting action of the seatback,
the second engagement member is configured to prevent the second movable member from entering the movement path of the second engagement member when the seatback is tilted rearward beyond the restriction range,
the interlocking mechanism is configured to maintain an engagement/disengagement attitude of the first movable member when the second movable member is prevented from entering the movement path, and
the first engagement member is configured to restrict the engagement/disengagement state between the first engagement member and the first movable member from being changed from one of an engaged state and a disengaged state to the other when the engagement/disengagement attitude of the first movable member is maintained by the interlocking mechanism.

3. The vehicle seat device according to claim 1, wherein
the second movable member is configured to enter the movement path of the second engagement member to define a restriction range of tilting action of the seatback,
the second engagement member is configured to prevent the second movable member from entering the movement path of the second engagement member when the seatback is tilted rearward beyond the restriction range,
the interlocking mechanism is configured to maintain an engagement/disengagement attitude of the first movable member when the second movable member is prevented from entering the movement path, and
the first engagement member is configured to restrict the engagement/disengagement state between the first engagement member and the first movable member from being changed from one of an engaged state and a disengaged state to the other when the engagement/disengagement attitude of the first movable member is maintained by the interlocking mechanism.

4. The vehicle seat device according to claim 2, wherein
the first engagement member includes a restricting engagement portion, and
the restricting engagement portion is engaged with the first movable member the engagement/disengagement attitude of which is maintained by the interlocking mechanism, thereby restricting a rearward movement of the seat that accompanies a change in the engagement/disengagement state between the first engagement member and the first movable member.

5. The vehicle seat device according to claim 1, further comprising a support portion, which supports the second movable member, which has entered the movement path of the second engagement member, from behind.

6. The vehicle seat device according to claim 5, wherein the support portion is a stopper portion, which is engaged with the second engagement member, thereby defining a maximum rearward tilt position of the seat back.

7. The vehicle seat device according to claim 1, wherein
the second movable member is a slider, which has a locking portion at one end,
the slider is interlocked with the first movable member to reciprocate so that the locking portion approaches or moves away from the movement path of the second engagement member, and
the slider reciprocates on a straight line, which passes through a tilt axis of the seatback.

8. The vehicle seat device according to claim 1, wherein
the interlocking mechanism includes a gradual-change mechanism,
the gradual-change mechanism increases an actuation amount of the second movable member entering the movement path of the second engagement member in accordance with increase in a rearward movement amount of the seat when the seat has moved into the rear movement region, and
the second movable member is configured to narrow the rearward tilting action range of the seatback in accordance with increase in the actuation amount of entry into the movement path of the second engagement member.

9. The vehicle seat device according to claim 8, wherein
the second movable member is configured to enter the movement path of the second engagement member while being supported from behind, and
the second movable member is configured such that an insertion width arranged in the movement path increases in accordance with increase in the actuation amount of entry into the movement path.

10. The vehicle seat device according to claim 9, wherein
the second movable member is a slider, which has a locking portion at one end,
the slider is interlocked with the first movable member to reciprocate so that the locking portion approaches or moves away from the movement path of the second engagement member, and
the locking portion is configured to taper toward a distal end.

11. The vehicle seat device according to claim 10, wherein the locking member tapers in a stepwise manner.

12. The vehicle seat device according to claim 8, wherein
the gradual-change mechanism includes a gradual-change engagement portion, and
the gradual-change engagement portion is engaged with the first movable member when the seat is in the rear movement region, thereby increasing the actuation amount of the first movable member in accordance with increase in the rearward movement amount of the seat.

13. The vehicle seat device according to claim 12, wherein the gradual-change engagement portion includes an engagement portion, which has a height that changes from the front to the rear.

14. The vehicle seat device according to claim 1, wherein
the second movable member is provided on a first support member that is supported on the slide rail and moves forward and rearward integrally with the seat, and
the second engagement member is provided on a second support member that is coupled to the first support member so as to be rotational relative to the first support member.

15. The vehicle seat device according to claim 2, further comprising a support portion, which supports the second movable member, which has entered the movement path of the second engagement member, from behind.

16. The vehicle seat device according to claim 2, wherein
the second movable member is a slider, which has a locking portion at one end,
the slider is interlocked with the first movable member to reciprocate so that the locking portion approaches or moves away from the movement path of the second engagement member, and
the slider reciprocates on a straight line, which passes through a tilt axis of the seatback.

17. The vehicle seat device according to claim 2, wherein
the interlocking mechanism includes a gradual-change mechanism,
the gradual-change mechanism increases an actuation amount of the second movable member entering the movement path of the second engagement member in accordance with increase in a rearward movement amount of the seat when the seat has moved into the rear movement region, and
the second movable member is configured to narrow the rearward tilting action range of the seatback in accordance with increase in the actuation amount of entry into the movement path of the second engagement member.

18. The vehicle seat device according to claim 17, wherein
the second movable member is configured to enter the movement path of the second engagement member while being supported from behind, and
the second movable member is configured such that an insertion width arranged in the movement path increases in accordance with increase in the actuation amount of entry into the movement path.

19. The vehicle seat device according to claim 17, wherein
the gradual-change mechanism includes a gradual-change engagement portion, and
the gradual-change engagement portion is engaged with the first movable member when the seat is in the rear movement region, thereby increasing the actuation amount of the first movable member in accordance with increase in the rearward movement amount of the seat.

20. The vehicle seat device according to claim 2, wherein
the second movable member is provided on a first support member that is supported on the slide rail and moves forward and rearward integrally with the seat, and
the second engagement member is provided on a second support member that is coupled to the first support member so as to be rotational relative to the first support member.
